(19) United States
(12) Patent Application Publication
(10) Pub. No.: US 2026/0225924 A1
(43) Pub. Date: Aug. 6, 2026

(54) METHODS AND APPARATUSES FOR GALVANIC ION EXTRACTION

(71) Applicant: Lithios Inc., Cambridge, MA (US)

(72) Inventors: Martin Z. Bazant, Wellesley, MA (US); Mathew E. Suss, Newton, MA (US); Michael J. Wang, Cambridge, MA (US); Mohammad A. Alkhadra, Boston, MA (US)

(73) Assignee: Lithios Inc., Cambridge, MA (US)

(21) Appl. No.: 19/150,479

(22) PCT Filed: Jan. 23, 2024
(86) PCT No.: PCT/US2024/012533

§ 371 Date: Jul. 23, 2025

Related U.S. Application Data
(60) Provisional application No. 63/440,889, filed on Jan. 24, 2023.
(60) Provisional application No. 63/444,484, filed on Feb. 9, 2023.
(60) Provisional application No. 63/513,519, filed on Jul. 13, 2023.
(60) Provisional application No. 63/513,532, filed on Jul. 13, 2023.
(60) Provisional application No. 63/513,538, filed on Jul. 13, 2023.

(51) Int. Cl. C02F 1/461; C02F 1/467; C02F 101/20; C02F 103/00; C02F 103/06; C02F 103/08

(52) U.S. Cl. CPC C02F 1/46176; C02F 1/46109; C02F 1/4672; C02F 2001/46138; C02F 2001/46161; C02F 2101/20; C02F 2103/007; C02F 2103/06; C02F 2103/08; C02F 2201/4611; C02F 2201/46165

(57) ABSTRACT

The present disclosure generally relates to apparatuses and methods for extraction of ions, including lithium ions. For example, certain aspects are generally directed to galvanic ion extraction techniques, which spontaneously passes current driven by potential differences between ions in two different fluids (e.g., one rich in a target ion, such as lithium, and one poor in the target ion). In some embodiments, target ions may be incorporated (e.g., deposited, intercalated, etc.) from an ion-rich fluid into a first electrode, while target ions may be removed from a second electrode into an ion-poor fluid, and in certain cases, the fluids may be intermittently switched, for example, such that the target ions may be removed from the first electrode and incorporated into the second electrode. In addition, certain embodiments are generally directed to a stack of compartments containing such electrodes, e.g., separated by anion-selective membranes, where the fluids may be alternated between adjacent compartments and anions passed across the anion-selective membranes to create the potential differences.

### RELATED APPLICATIONS

This application claims the benefit of U.S. Provisional Patent Application Ser. No. 63/440,889, filed Jan. 24, 2023, entitled “Methods and Apparatuses for Galvanic Ion Extraction”; U.S. Provisional Patent Application Ser. No. 63/444,484, filed Feb. 9, 2023, entitled “Flow Field Configurations and Methods for Separation Processes”; U.S. Provisional Patent Application Ser. No. 63/513,519, filed Jul. 13, 2023, entitled “Methods and Apparatuses for Electrochemical Ion Exchange”; U.S. Provisional Patent Application Ser. No. 63/513,532, filed Jul. 13, 2023, entitled “Processes and Apparatuses for Enriching Solutions”; and U.S. Provisional Patent Application Ser. No. 63/513,538, filed Jul. 13, 2023, entitled “Flow Systems and Methods for Membraneless Separation.” Each of the above is incorporated herein by reference.

### FIELD

The present disclosure generally relates to apparatuses and methods for extraction of ions, including lithium ions. In some embodiments, the present disclosure also relates to apparatuses and methods of harvesting energy from salinity differences, e.g., simultaneously with the extraction of ions.

### BACKGROUND

Existing chemical methods are inadequate to meet the exploding global demand for lithium extraction from diverse feedstocks, including mineral deposits, brines and recycled batteries. A variety of techniques exist, including hard-rock mining of lithium minerals with extraction using hydrometallurgical processes such as solvent extraction and precipitation, brine extraction using techniques such as solar evaporation and sequential precipitation of mineral salts in massive ponds, direct lithium extraction by ion exchange, metal battery recycling using deep-discharging, dismantling, crushing and grinding of cells with either dry sieving, solvent treatments or high temperature calcination, or electrolytic methods.

Electrolytic methods of recovering dissolved metals from aqueous electrolytes have been known for at least half a century. An electrolytic cell requires electrical energy input (in the form of an applied voltage) to drive Faradaic half-cell oxidation reactions (producing electrons) at the anode and Faradaic half-cell reduction reactions (consuming electrons) at the cathode. Electrolytic recovery of metal cations involves three steps: 1. metal extraction by the selective reduction of metal cations at a collection electrode immersed in the feed solution, polarized as a cathode; 2. solution exchange by immersing the electrode in the recovery solution; and 3. metal release by selective oxidation, reversing the current to polarize the electrode as an anode in the recovery solution. However, it is very difficult to separate transition metals and/or lithium by electrodeposition from complex aqueous solutions. A direct electrodeposit would typically contain an unstable, heterogeneous mixture of the different metals, which cannot be easily separated. Accordingly, improvements in recovery techniques for lithium and other ions are still needed.

### SUMMARY

The present disclosure generally relates to apparatuses and methods for extraction of ions, including lithium ions. In some embodiments, the present disclosure also relates to apparatuses and methods of harvesting energy from salinity differences, e.g., simultaneously with the extraction of ions. This may be useful, in certain cases, to drive ion extraction, e.g., as a galvanic electrochemical cell. The subject matter of the present disclosure involves, in some cases, interrelated products, alternative solutions to a particular problem, and/or a plurality of different uses of one or more devices and/or apparatuses.

One aspect is generally directed to an apparatus for galvanic lithium extraction. In accordance with one set of embodiments, the apparatus comprises a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack; a source of a lithium-rich fluid; a source of a lithium-poor fluid; a flow-switching element able to switch between a first state and a second state, wherein: (i) in the first state, fluid from the source of the lithium-rich fluid is in fluid communication with the first group of compartments and fluid from the source of the lithium-poor fluid is in fluid communication with the second group of compartments, and (ii) in the second state, fluid from the source of the lithium-rich fluid is in fluid communication with the second group of compartments and fluid from the source of the lithium-poor fluid is in fluid communication with the first group of compartments; and an electrical pathway connecting the electrodes of the first group of compartments and the electrodes of the second group of compartments, the electrical pathway being free of a voltage source.

In another set of embodiments, the apparatus comprises a stack comprising a plurality of repeat units, each repeat unit comprising a compartment containing a lithium-selective electrode and being separated from an adjacent repeat unit by an anion-selective membrane; a first electrical network in electrical communication with a first group of the lithium-selective electrodes; a second electrical network in electrical communication with a second group of the lithium-selective electrodes, wherein the electrodes of the first group of electrodes and the electrodes of the second group of electrodes alternate within the stack; and an electrical pathway connecting the first group of electrodes and the second group of electrodes, the electrical pathway being free of a voltage source.

The apparatus, in yet another set of embodiments, comprises a first compartment containing a first lithium-selective electrode; a second compartment containing a second lithium-selective electrode; an anion-selective membrane separating the first compartment and the second compartment; a source of a lithium-rich fluid; a source of a lithium-poor fluid; a flow-switching element able to switch between a first state and a second state, wherein: (i) in the first state, fluid from the source of the lithium-rich fluid is in fluid communication with the first compartment and fluid from the source of the lithium-poor fluid is in fluid communication with the second compartment, and (ii) in the second state, fluid from the source of the lithium-rich fluid is in fluid communication with the second compartment and fluid from the source of the lithium-poor fluid is in fluid communication with the first compartment; and an electrical pathway connecting the first lithium-selective electrode in the first compartment and the second lithium-selective electrode in the second compartment, the electrical pathway being free of a voltage source.

The apparatus, in still another set of embodiments, comprises a first compartment containing a first lithium-selective electrode; a second compartment containing a second lithium-selective electrode; an anion-selective membrane separating the first compartment and the second compartment; a source of a lithium-rich fluid in fluid communication with the first compartment; a source of a lithium-poor fluid in fluid communication with the second compartment; and an electrical pathway connecting the first lithium-selective electrode in the first compartment and the second lithium-selective electrode in the second compartment, the electrical pathway being free of a voltage source.

In one set of embodiments, the apparatus comprises a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, the compartments of the first group of compartments and the compartments of the second group of compartments alternating within the stack; a source of a first fluid rich in the target ion; a source of a second fluid poor in the target ion; a flow-switching element able to switch between a first state and a second state, wherein: (i) in the first state, fluid from the source of the first fluid is in fluid communication with the first group of compartments and fluid from the source of the second fluid is in fluid communication with the second group of compartments, and (ii) in the second state, fluid from the source of the first fluid is in fluid communication with the second group of compartments and fluid from the source of the second fluid is in fluid communication with the first group of compartments; and an electrical pathway connecting the electrodes of the first group of compartments and the electrodes of the second group of compartments, the electrical pathway being free of a voltage source.

In another set of embodiments, the apparatus comprises a stack comprising a plurality of repeat units, each repeat unit comprising a compartment containing an electrode selective to the target ion and being separated from an adjacent repeat unit by a counterion-selective membrane; a first electrical network in electrical communication with a first group of the electrodes selective to the target ion; a second electrical network in electrical communication with a second group of the electrodes selective to the target ion, wherein the electrodes of the first group of electrodes and the electrodes of the second group of electrodes alternate within the stack; and an electrical pathway connecting the first group of electrodes and the second group of electrodes, the electrical pathway being free of a voltage source.

The apparatus, in still another set of embodiments, comprises a first compartment containing a first electrode selective to the target ion; a second compartment containing a second electrode selective to the target ion; a counterion-selective membrane separating the first compartment and the second compartment; a source of a first fluid rich in the target ion; a source of a second fluid poor in the target ion; a flow-switching element able to switch between a first state and a second state, wherein: (i) in the first state, fluid from the source of the first fluid is in fluid communication with the first compartment and fluid from the source of the second fluid is in fluid communication with the second compartment, and (ii) in the second state, fluid from the source of the first fluid is in fluid communication with the second compartment and fluid from the source of the second fluid is in fluid communication with the first compartment; and an electrical pathway connecting the first electrode in the first compartment and the second electrode in the second compartment, the electrical pathway being free of a voltage source.

In yet another set of embodiments, the apparatus comprises a first compartment containing a first electrode selective to the target ion; a second compartment containing a second electrode selective to the target ion; a counterion-selective membrane separating the first compartment and the second compartment; a source of a first fluid rich in the target ion in fluid communication with the first compartment; a source of a second fluid poor in the target ion in fluid communication with the second compartment; and an electrical pathway connecting the first electrode in the first compartment and the second electrode in the second compartment, the electrical pathway being free of a voltage source.

Another aspect is generally directed to an apparatus for galvanic extraction of a target ion. In one set of embodiments, the apparatus comprises a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, the compartments of the first group of compartments and the compartments of the second group of compartments alternating within the stack; a source of a first fluid rich in the target ion; a source of a second fluid poor in the target ion; a flow-switching element able to switch between a first state and a second state, wherein: (i) in the first state, fluid from the source of the first fluid is in fluid communication with the first group of compartments and fluid from the source of the second fluid is in fluid communication with the second group of compartments, and (ii) in the second state, fluid from the source of the first fluid is in fluid communication with the second group of compartments and fluid from the source of the second fluid is in fluid communication with the first group of compartments; and an electrical pathway connecting the electrodes of the first group of compartments and the electrodes of the second group of compartments, the electrical pathway being free of a voltage source.

The apparatus, in yet another set of embodiments, comprises a stack comprising a plurality of repeat units, each repeat unit comprising a compartment containing an electrode selective to the target ion and being separated from an adjacent repeat unit by an counterion-selective membrane; a first electrical network in electrical communication with a first group of the electrodes selective to the target ion; a second electrical network in electrical communication with a second group of the electrodes selective to the target ion, wherein the electrodes of the first group of electrodes and the electrodes of the second group of electrodes alternate within the stack; and an electrical pathway connecting the first group of electrodes and the second group of electrodes, the electrical pathway being free of a voltage source.

According to still another set of embodiments, the apparatus comprises a first compartment containing a first electrode selective to the target ion; a second compartment containing a second electrode selective to the target ion; an counterion-selective membrane separating the first compartment and the second compartment; a source of a first fluid rich in the target ion; a source of a second fluid poor in the target ion; a flow-switching element able to switch between a first state and a second state, wherein: (i) in the first state, fluid from the source of the first fluid is in fluid communication with the first compartment and fluid from the source of the second fluid is in fluid communication with the second compartment, and (ii) in the second state, fluid from the source of the first fluid is in fluid communication with the second compartment and fluid from the source of the second fluid is in fluid communication with the first compartment; and an electrical pathway connecting the first electrode in the first compartment and the second electrode in the second compartment, the electrical pathway being free of a voltage source.

The apparatus, in yet another set of embodiments, comprises a first compartment containing a first electrode selective to the target ion; a second compartment containing a second electrode selective to the target ion; an counterion-selective membrane separating the first compartment and the second compartment; a source of a first fluid rich in the target ion in fluid communication with the first compartment; a source of a second fluid poor in the target ion in fluid communication with the second compartment; and an electrical pathway connecting the first electrode in the first compartment and the second electrode in the second compartment, the electrical pathway being free of a voltage source.

Yet another aspect is generally directed to a method for galvanic extraction of lithium. In accordance with one set of embodiments, the method comprises providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack; at a first time, flowing a lithium-rich fluid through the first group of compartments and a lithium-poor fluid through the second group of compartments such that anions pass across the anion-selective membrane from the first group of compartments to the second group of compartments, and current flows from the electrodes of the first group of compartments to the electrodes of the second group of compartments; and at a second time, flowing the lithium-rich fluid through the second group of compartments and the lithium-poor fluid through the first group of compartments such that anions pass across the anion-selective membrane from the second group of compartments to the first group of compartments, and current flows from the electrodes of the second group of compartments to the electrodes of the first group of compartments.

The method, in another set of embodiments, comprises providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack; at a first time, flowing a lithium-rich fluid through the first group of compartments and a lithium-poor fluid through the second group of compartments such that anions pass across the anion-selective membrane from the first group of compartments to the second group of compartments, without imposing an external potential therebetween; and at a second time, flowing the lithium-rich fluid through the second group of compartments and the lithium-poor fluid through the first group of compartments such that anions pass across the anion-selective membrane from the second group of compartments to the first group of compartments, without imposing an external potential therebetween.

The method, in yet another set of embodiments, comprises providing a stack comprising a plurality of repeat units, each repeat unit comprising a lithium-selective electrode and being separated from an adjacent repeat unit by an anion-selective membrane, wherein the lithium-selective electrodes comprise a first group of electrodes in electrical communication via a first electrical network and a second group of electrodes in electrical communication via a second electrical network, the electrodes of the first group of electrodes and the electrodes of the second group of electrodes alternating within the stack; at a first time, incorporating lithium ions in the first group of electrodes, removing lithium ions from the second group of electrodes, passing anions across the anion-selective membrane in a first direction, and creating a potential between the first group of electrodes and the second group of electrodes, wherein the potential causes current to flow from the first group of electrodes to the second group of electrodes; and at a second time, removing lithium ions from the first group of electrodes, incorporating lithium ions in the second group of electrodes, passing anions across the anion-selective membrane in a second direction opposite the first direction, and creating a potential between the second group of electrodes and the first group of electrodes, wherein the potential causes current to flow from the second group of electrodes to the first group of electrodes.

In one set of embodiments, the method comprises providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, wherein the compartments of the first group of compartments and the compartments of the second group of compartments alternate within the stack; flowing a lithium-rich fluid through the first group of compartments; flowing a lithium-poor fluid through the second group of compartments; passing anions across the anion-selective membrane from the first group of compartments to the second group of compartments; and passing current from the electrodes of the first group of compartments to the electrodes of the second group of compartments.

In another set of embodiments, the method comprises providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, wherein the compartments of the first group of compartments and the compartments of the second group of compartments alternate within the stack; flowing a lithium-rich fluid through the first group of compartments; flowing a lithium-poor fluid through the second group of compartments; passing anions across the anion-selective membranes from the first group of compartments to the second group of compartments; and causing current to flow from the electrodes of the first group of compartments to the electrodes of the second group of compartments without imposing an external potential therebetween.

The method, in yet another set of embodiments, comprises providing a stack comprising a plurality of repeat units, each repeat unit comprising a lithium-selective electrode and being separated from an adjacent repeat unit by an anion-selective membrane, wherein the lithium-selective electrodes comprise a first group of electrodes in electrical communication via a first electrical network and a second group of electrodes in electrical communication via a second electrical network, wherein the electrodes of the first group of electrodes and the electrodes of the second group of electrodes alternate within the stack; incorporating lithium ions in the first group of electrodes; removing lithium ions from the second group of electrodes; passing anions across the anion-selective membrane; and causing current to flow from the first group of electrodes to the second group of electrodes.

In still another set of embodiments, the method comprises providing a first compartment containing a first lithium-selective electrode and a second compartment containing a second lithium-selective electrode, the first compartment and the second compartment being separated by an anion-selective membrane; at a first time, flowing a lithium-rich fluid through the first compartment and a lithium-poor fluid through the second compartment such that anions pass across the anion-selective membrane from the first compartment to the second compartment, and current flows from the first lithium-selective electrode to the second lithium-selective electrode; and at a second time, flowing the lithium-rich fluid through the second compartment and the lithium-poor fluid through the first compartment such that anions pass across the anion-selective membrane from the second compartment to the first compartment, and current flows from the second lithium-selective electrode to the first lithium-selective electrode.

In another set of embodiments, the method comprises providing a first compartment containing a first lithium-selective electrode and a second compartment containing a second lithium-selective electrode, the first compartment and the second compartment being separated by an anion-selective membrane; at a first time, flowing a lithium-rich fluid through the first compartment and a lithium-poor fluid through the second compartment such that anions pass across the anion-selective membrane from the first compartment to the second compartment, without imposing an external potential between the first electrode and the second electrode; and at a second time, flowing the lithium-rich fluid through the second compartment and the lithium-poor fluid through the first compartment such that anions pass across the anion-selective membrane from the second compartment to the first compartment, without imposing an external potential between the second electrode and the first electrode.

The method, in yet another set of embodiments, comprises providing a first compartment containing a first lithium-selective electrode and a second compartment containing a second lithium-selective electrode, the first compartment and the second compartment being separated by an anion-selective membrane; at a first time, incorporating lithium ions in the first lithium-selective electrode, removing lithium ions from the second lithium-selective electrode, passing anions across the anion-selective membrane in a first direction, and creating a potential between the first lithium-selective electrode and the second lithium-selective electrode, wherein the potential causes current to flow from the first lithium-selective electrode to the second lithium-selective electrode; and at a second time, removing lithium ions from the first lithium-selective electrode, incorporating lithium ions in the second lithium-selective electrode, passing anions across the anion-selective membrane in a second direction opposite the first direction, and creating a potential between the second lithium-selective electrode and the first lithium-selective electrode, wherein the potential causes current to flow from the second lithium-selective electrode to the first lithium-selective electrode.

In still another set of embodiments, the method comprises flowing a lithium-rich fluid through a first compartment containing a first lithium-selective electrode; flowing a lithium-poor fluid through a second compartment containing a second lithium-selective electrode; passing anions from the first compartment to the second compartment across an anion-selective membrane separating the first compartment and the second compartment; and creating a potential between the first lithium-selective electrode and the second lithium-selective electrode, wherein the potential causes current to flow from the first lithium-selective electrode to the second lithium-selective electrode.

In one set of embodiments, the method comprises flowing a lithium-rich fluid through a first compartment containing a first lithium-selective electrode; flowing a lithium-poor fluid through a second compartment containing a second lithium-selective electrode; passing anions from the first compartment to the second compartment across an anion-selective membrane separating the first compartment and the second compartment; and passing a current from the first lithium-selective electrode to the second lithium-selective electrode without imposing an external potential therebetween.

According to another set of embodiments, the method comprises incorporating lithium ions in a first lithium-selective electrode in a first compartment; removing lithium ions from a second lithium-selective electrode in a second compartment; passing anions across an anion-selective membrane separating the first compartment and the second compartment; and creating a potential between the first lithium-selective electrode and the second lithium-selective electrode, wherein the potential causes current to flow from the first lithium-selective electrode to the second lithium-selective electrode.

Still another aspect is generally directed to a method for galvanic extraction of a target ion. In one set of embodiments, the method comprises providing a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, the compartments of the first group of compartments and the compartments of the second group of compartments alternating within the stack; at a first time, flowing a first fluid rich in the target ion through the first group of compartments and a second fluid poor in the target ion through the second group of compartments such that anions pass across the counterion-selective membrane from the first group of compartments to the second group of compartments, and current flows from the electrodes of the first group of compartments to the electrodes of the second group of compartments; and at a second time, flowing the first fluid the second group of compartments and the second fluid through the first group of compartments such that anions pass across the counterion-selective membrane from the second group of compartments to the first group of compartments, and current flows from the electrodes of the second group of compartments to the electrodes of the first group of compartments.

In another set of embodiments, the method comprises providing a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, the compartments of the first group of compartments and the compartments of the second group of compartments alternating within the stack; at a first time, flowing a first fluid rich in the target ion through the first group of compartments and a second fluid poor in the target ion through the second group of compartments such that anions pass across the counterion-selective membrane from the first group of compartments to the second group of compartments, without imposing an external potential therebetween; and at a second time, flowing the first fluid through the second group of compartments and the second fluid through the first group of compartments such that anions pass across the counterion-selective membrane from the second group of compartments to the first group of compartments, without imposing an external potential therebetween.

The method, in yet another set of embodiments, comprises providing a stack comprising a plurality of repeat units, each repeat unit comprising an electrode selective to the target ion and being separated from an adjacent repeat unit by an counterion-selective membrane, wherein the electrodes comprise a first group of electrodes in electrical communication via a first electrical network and a second group of electrodes in electrical communication via a second electrical network, the electrodes of the first group of electrodes and the electrodes of the second group of electrodes alternating within the stack; at a first time, incorporating target ions in the first group of electrodes, removing target ions from the second group of electrodes, passing anions across the counterion-selective membrane in a first direction, and creating a potential between the first group of electrodes and the second group of electrodes, wherein the potential causes current to flow from the first group of electrodes to the second group of electrodes; and at a second time, removing target ions from the first group of electrodes, incorporating target ions in the second group of electrodes, passing anions across the counterion-selective membrane in a second direction opposite the first direction, and creating a potential between the second group of electrodes and the first group of electrodes, wherein the potential causes current to flow from the second group of electrodes to the first group of electrodes.

In one set of embodiments, the method comprises providing a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, wherein the compartments of the first group of compartments and the compartments of the second group of compartments alternate within the stack; flowing a first fluid rich in the target ion through the first group of compartments; flowing a second fluid poor in the target ion through the second group of compartments; passing anions across the counterion-selective membrane from the first group of compartments to the second group of compartments; and passing current from the electrodes of the first group of compartments to the electrodes of the second group of compartments.

In another set of embodiments, the method comprises providing a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, wherein the compartments of the first group of compartments and the compartments of the second group of compartments alternate within the stack; flowing a first fluid rich in the target ion through the first group of compartments; flowing a second fluid poor in the target ion through the second group of compartments; passing anions across the counterion-selective membranes from the first group of compartments to the second group of compartments; and causing current to flow from the electrodes of the first group of compartments to the electrodes of the second group of compartments without imposing an external potential therebetween.

The method, in yet another set of embodiments, comprises providing a stack comprising a plurality of repeat units, each repeat unit comprising an electrode selective to the target ion and being separated from an adjacent repeat unit by an counterion-selective membrane, wherein the electrodes comprise a first group of electrodes in electrical communication via a first electrical network and a second group of electrodes in electrical communication via a second electrical network, wherein the electrodes of the first group of electrodes and the electrodes of the second group of electrodes alternate within the stack; incorporating target ions in the first group of electrodes; removing target ions from the second group of electrodes; passing anions across the counterion-selective membrane; and causing current to flow from the first group of electrodes to the second group of electrodes.

According to one set of embodiments, the method comprises providing a first compartment containing a first electrode selective to the target ion and a second compartment containing a second electrode selective to the target ion, the first compartment and the second compartment being separated by an counterion-selective membrane; at a first time, flowing a first fluid rich in the target ion through the first compartment and a second fluid poor in the target ion through the second compartment such that anions pass across the counterion-selective membrane from the first compartment to the second compartment, and current flows from the first electrode to the second electrode; and at a second time, flowing the first fluid through the second compartment and the second fluid through the first compartment such that anions pass across the counterion-selective membrane from the second compartment to the first compartment, and current flows from the second electrode to the first electrode.

In another set of embodiments, the method comprises providing a first compartment containing a first electrode selective to the target ion and a second compartment containing a second electrode selective to the target ion, the first compartment and the second compartment being separated by an counterion-selective membrane; at a first time, flowing a first fluid rich in the target ion through the first compartment and a second fluid poor in the target ion through the second compartment such that anions pass across the counterion-selective membrane from the first compartment to the second compartment, without imposing an external potential between the first electrode and the second electrode; and at a second time, flowing the first fluid through the second compartment and the second fluid through the first compartment such that anions pass across the counterion-selective membrane from the second compartment to the first compartment, without imposing an external potential between the second electrode and the first electrode.

The method, in still another set of embodiments, comprises providing a first compartment containing a first electrode selective to the target ion and a second compartment containing a second electrode selective to the target ion, the first compartment and the second compartment being separated by an counterion-selective membrane; at a first time, incorporating target ions in the first electrode, removing target ions from the second electrode, passing anions across the counterion-selective membrane in a first direction, and creating a potential between the first electrode and the second electrode, wherein the potential causes current to flow from the first electrode to the second electrode; and at a second time, removing target ions from the first electrode, incorporating target ions in the second electrode, passing anions across the counterion-selective membrane in a second direction opposite the first direction, and creating a potential between the second electrode and the first electrode, wherein the potential causes current to flow from the second electrode to the first electrode.

In one set of embodiments, the method comprises flowing a first fluid rich in the target ion through a first compartment containing a first electrode selective to the target ion; flowing a second fluid poor in the target ion through a second compartment containing a second electrode selective to the target ion; passing anions from the first compartment to the second compartment across an counterion-selective membrane separating the first compartment and the second compartment; and creating a potential between the first electrode and the second electrode, wherein the potential causes current to flow from the first electrode to the second electrode.

According to another set of embodiments, the method comprises flowing a first fluid rich in the target ion through a first compartment containing a first electrode selective to the target ion; flowing a second fluid poor in the target ion through a second compartment containing a second electrode selective to the target ion; passing anions from the first compartment to the second compartment across an counterion-selective membrane separating the first compartment and the second compartment; and passing a current from the first electrode to the second electrode without imposing an external potential therebetween.

In yet another set of embodiments, the method comprises incorporating target ions in a first electrode selective to the target ion in a first compartment; removing target ions from a second electrode selective to the target ion in a second compartment; passing anions across an counterion-selective membrane separating the first compartment and the second compartment; and creating a potential between the first electrode and the second electrode, wherein the potential causes current to flow from the first electrode to the second electrode.

In another aspect, the present disclosure encompasses methods of making one or more of the embodiments described herein, for example, a method for galvanic extraction of a target cation, such as lithium. In still another aspect, the present disclosure encompasses methods of using one or more of the embodiments described herein, for example, a method for galvanic extraction of a target cation, such as lithium.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic diagram of two compartments and the flow of ions therein, in accordance with one embodiment;

FIG. 2 is a schematic diagram of an apparatus, in another embodiment;

FIG. 3 illustrates certain ionic flows within an apparatus, in still another embodiment;

FIGS. 4A-4E illustrate various stack geometries, in yet another embodiment;

FIGS. 5A-5C illustrate various example electrode configurations, in other embodiments;

FIG. 6 illustrates an example flow-switching element, in still another embodiment;

FIGS. 7A-7D illustrate various modes of operation for solid solution electrodes, in accordance with certain embodiments;

FIGS. 8A-8D illustrate various modes of operation phase-separating electrodes, in accordance with certain embodiments;

FIGS. 9A-9C illustrate an example system for ion extraction, in certain embodiments;

FIG. 10 illustrates voltage response during supergalvanic ion extraction, in yet another embodiment;

FIGS. 11A-11B illustrates data obtained from another embodiment using multiple cycles of Li extraction and release from the electrodes;

FIG. 12 illustrates supergalvanic electroswing adsorption, in still another embodiment; and

FIGS. 13A-13D illustrate various flow field designs, in certain embodiments.

### DETAILED DESCRIPTION

The present disclosure generally relates to apparatuses and methods for extraction of ions, including lithium ions. In some embodiments, the present disclosure also relates to apparatuses and methods of harvesting energy from salinity differences, e.g., simultaneously with the extraction of ions. For example, certain aspects are generally directed to galvanic ion extraction techniques, which spontaneously passes current driven by potential differences between ions in two different fluids (e.g., one rich in a target ion, such as lithium, and one poor in the target ion). In some embodiments, target ions may be incorporated (e.g., deposited, intercalated, etc.) from an ion-rich fluid into a first electrode, while target ions may be removed from a second electrode into an ion-poor fluid, and in certain cases, the fluids may be intermittently switched, for example, such that the target ions may be removed from the first electrode and incorporated into the second electrode. In addition, certain embodiments are generally directed to a stack of compartments containing such electrodes, e.g., separated by anion-selective membranes, where the fluids may be alternated between adjacent compartments and anions passed across the anion-selective membranes to create the potential differences.

Certain aspects as discussed herein are generally directed to galvanic ion extraction techniques, which spontaneously passes current driven by electrochemical potential differences between ions in the first and second fluids, and the electrodes. In some embodiments, an apparatus may include a layered stack of membranes (e.g., ion-selective membranes, such as reverse electrodialysis membranes), electrodes, current collectors, and flow channels. The apparatus may perform selective electrosorption of target ions from a target ion-rich solution and cause electro-desorption of target ions into a target ions-poor solution (e.g., a recovery solution). In some embodiments, ion exchange membranes may be used to enhance selectivity, control the flow of specific ions, and/or generate additional power. For instance, in some cases, electrical energy can be produced from the salinity difference of the first and second (recovery) fluids, which can be used to provide some additional power, for example, to accelerate the ion extraction process, e.g., as a supergalvanic process.

In one embodiment involving short-circuited electrodes, the apparatus can passively extract lithium, e.g., without requiring any electrical input. The rate of passive ion extraction process can be controlled by varying the external resistance, in order to improve the efficiency of separation. At low rates, e.g., below the short-circuit current, the apparatus can operate as a galvanic cell, e.g., producing electricity during lithium extraction, which can be stored, used for autonomous system operation, used externally, etc. At higher rates, the apparatus may be operated as a super-galvanic cell, consuming some electricity to accelerate the extraction process, and in some cases in addition to energy harvested from salinity differences.

In some cases, without changing the system, the energy balance and flow rate can be controlled to control or tune the rate and/or efficiency of lithium production. For example, in one embodiment, the apparatus may be located near a source of fresh water, e.g., to drive lithium extraction and potentially generate electricity while extracting lithium; for example, the apparatus may be used to produce lithium from seawater at a river estuary.

In some embodiments, the apparatus can be modified to produce lithium products in fewer unit operations. In addition, in some cases, the apparatus can be modified to produce chemicals derived from the extracted ions, such as lithium chemicals from lithium ions, e.g., in fewer unit operations.

In some embodiments, the second fluid, after exiting the apparatus, may contain lithium ions paired with anions from the first fluid, such as chloride and/or sulfate, etc. In some embodiments, the second fluid may include reagents that allow the apparatus to directly produce lithium hydroxide, lithium carbonate, or other lithium chemicals.

One set of embodiments is generally directed to apparatuses and methods for galvanic ion extraction, in which target ions may be selectively removed from a first fluid that contains other competing ions of the same charge. The ion removal may be driven spontaneously by electrochemical potential differences between the first and second fluids and/or the electrodes, for example, using processes of reverse electrodialysis and/or reverse electrosorption. In one embodiment, the target ions are lithium ions (Li+), which may be contained, for example, in an aqueous brine or leachate that arises in mining or battery recycling.

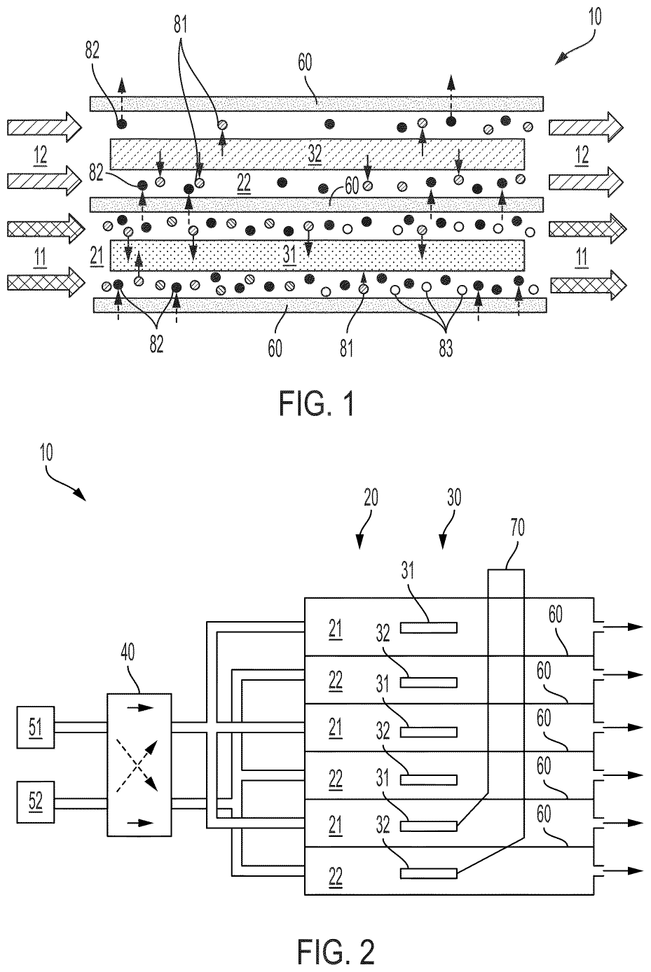

In one set of embodiments, selective reverse electrosorption of target ions is used, as combined with reverse electrodialysis of counterions (e.g., having opposite sign to the target ions) as shown in FIG. 1. In this figure, in apparatus 10, first fluid 11 (e.g., a target-ion rich fluid) passes through a first (lower) compartment 21, while second fluid 12 (e.g., a target-ion poor fluid) passes through a second (upper) compartment 22, separated by counterion-selective membrane 60. Target ions 81 become deposited or otherwise incorporated into target-ion depleted electrode 31 in first compartment 21, while target ions 81 are removed from target-ion enriched electrode 32 in second compartment 22. Meanwhile, counterions 82 pass through counterion selective membrane 60, while other co-ions 83 do not pass through.

In some embodiments to extract lithium or other target ions, a selective reverse electrosorption process may be used that involves electrodeposition/dissolution of the target ions at metal electrodes, optionally passing through cation-exchange membranes that are permselective to the target ions. In addition, in some embodiments, the selective reverse electrosorption process involves intercalation electrodes that select for the target ions. In one embodiment, the target ions are lithium ions; the counterions are chloride and sulfate ions; the reverse electrodialysis membrane is an anion exchange membrane; and the selective reverse electrosorption electrode comprises a Li-ion battery active material, optionally with coatings to enhance wettability and boost conductivity, e.g., as discussed herein.

In one embodiment, the apparatus may include a stack of alternating electrodes, membranes and flow channels. The apparatus may separate the target ions from liquid electrolytes in a stack of compartments separated by counterion selective ion-exchange membranes, which may separate alternating compartments of (1) target ion-rich fluid from which counterions are transported across the membranes and from which target ions are selectively captured by an electrode, and (2) target ion-poor fluid which collects the counterions that pass through the membranes and which is in contact with electrodes that selectively release target ions. In some cases, the fluids fed to the alternating chambers may be switched, e.g., periodically, to extract target ions and counterions from the target ion-rich fluid into the target ion-poor fluid, leading to net extraction of target ions (e.g., Li⁺) and counterions (e.g., Cl⁻).

One embodiment of an apparatus according to an aspect of the present disclosure is now described. (An example of such an apparatus is shown with reference to FIG. 2.) In some embodiments, an apparatus may be used to extract lithium ions from a first fluid (for example, one having a relatively high concentration of lithium ions, i.e., a lithium-rich fluid), and add them to a second fluid (for example, one having a relatively low concentration of lithium ions, i.e., a lithium-poor fluid). The first fluid may be, for example, a salt-lake brine, a subterranean brine, a geothermal brine, seawater, a leach liquor from hard-rock mining, a leachate from lithium-ion battery recycling, or other potential sources of lithium ions. Such fluids, in some embodiments, may also contain high concentrations of other co-ions (e.g., cations or positively charged ions) such as sodium, calcium, magnesium, potassium, or other competing ions, as well as high concentrations of counterions (e.g., anions or negatively charged ions) such as chloride, sulfate, hydroxide, or the like. The second fluid may be, for example, fresh water, naturally occurring water, desalinated water, distilled water, etc., which can then become concentrated in lithium ions (while not being as concentrated in other co-ions) as described in this example, e.g., for subsequent processing or use. Thus, lithium ions from the first fluid may become purified and/or concentrated within the second fluid. In addition, it should be understood that while this example describes the purification of lithium ions, this is for ease of presentation only, and that in other embodiments such as are described herein, other ions instead of lithium may be separated, for example, using electrodes that are optionally covered with ion-selective membranes, for example, that are capable of selective reverse electrosorption of those ions.

In some cases, the target ion may include metal ions. As a non-limiting example, target metal ions such as sodium, potassium, silver, gold, aluminum, zinc, nickel, or copper ions, etc., may be extracted by electrodeposition electrodes (e.g., by controlling the voltage to exploit differences in standard reduction potentials of species in solution). As another non-limiting example, ions, such as lithium and sodium, may be extracted by electrodeposition electrodes after passing through selective solid-state membranes (e.g., LIPON, LISICON, NASICON etc.), or task-specific ionic liquids (e.g., which selectively chelate the target ions). In another example, target ions such as sodium, potassium, chloride, protons, hydronium, or hydroxide ions may be extracted by selective intercalation electrodes (e.g., Prussian blue, Prussian blue analogues, nickel or other metal hexacyanoferrates, Prussian white, Prussian white analogues, etc.), etc. Non-limiting examples of sodium or potassium selective intercalation electrode materials include Prussian blue (Fe₄[Fe(CN)₆]₃), Prussian blue analogues, Prussian white (Na₂Fe₂(CN)₆), Prussian white analogues (e.g., nickel hexacyanoferrate, Na₂NiFe(CN)₆, manganese hexanoferrate (Na₂MnFe(CN)₆,), etc. Non-limiting examples of sodium-ion intercalation materials include sodium manganese oxide (NMO), sodium vanadium oxide (NVO), sodium iron phosphate (NFP), sodium titanium phosphate (NTP), Prussian blue analogues (PBA), Prussian white analogues (PWA), carbon nanomaterials, or the like. In one embodiment, an active material may comprise a potassium-ion intercalation material. Non-limiting examples of potassium-ion intercalation materials include potassium manganese oxide (KMO), potassium vanadium oxide (KVO), potassium iron phosphate (KFP), potassium vanadium phosphate (KVP), PBA, PWA, graphite, or the like. In another set of examples, the target ions are rare earth elements, such as lanthanides and actinides, which may be extracted by selective intercalation, for example, by metal hexanoferrates, Prussian blue or white analogues, other metal-organic framework (MOF) electrodes, or the like. In some cases, rare elements may be separated by size, for example, as the smaller, heavier ions may be intercalated more easily. Non-limiting examples of target ions may include metal lanthanides, such as lanthanum, cerium, neodymium, gadolinium, terbium, europium, etc., or metal actinides, such as uranium, plutonium, thorium, etc. Other examples are provided below.

The apparatus may include a plurality or “stack” of compartments, through which fluid can flow. The fluid may completely fill the compartments, and/or only a portion of the compartment may be filled with fluid. For example, in some cases, at least 10%, at least 20%, at least 30%, at least 40%, at least 50%, at least 60%, at least 70%, at least 80%, or at least 90% (by volume) of a compartment may be filled with a fluid.

Some or all of the compartments within the stack may also contain one, two, or more electrodes, such as a lithium-selective electrode, in which lithium ions may be incorporated into or removed from. In FIG. 2, this is shown as apparatus 10, with stack 20 and electrodes 30. Non-limiting examples of materials that may be used in the lithium-selective electrode include lithium iron phosphate, lithium titanium phosphate, lithium manganese oxide, or other materials such as those described herein. In addition, in some embodiments such as described in more detail below, the lithium-selective electrode may be porous, e.g., comprising particles, fibers, or the like to cause porosity, which may allow fluid to flow through the electrode in some cases. Each of the compartments may independently have the same or different electrodes therein. In some cases, for instance, all of the electrodes within a stack are compositionally identical other than the presence/absence of any deposited, electrosorbed, or intercalated lithium.

In some embodiments, the compartments within the stack are arranged in an alternating manner, where a first fluid is able to access a first set of compartments and a second fluid is able to access a second, interleaved set of compartments. Thus, for example, two adjacent compartments will not both contain fluid from the same source. In addition, in some cases, a flow-switching element may be used to intermittently switch the flows of fluid. For example, as schematically shown in FIG. 2, a first fluid from first source of fluid 51 may flow through a first set of compartments 21 and a second fluid from second source of fluid 52 may flow through a second set of compartments 22, while at a second point of time, the first fluid may flow through the second set of compartments 22 and the second fluid may flow through the first set of compartments 21.

Separating each of the compartments within the stack is a membrane or other separator, which may be an anion-selective membrane in certain instances. In FIG. 2, this is shown with membrane 60. The anion-selective membrane may be one that allows anions such as chloride to pass through, while preventing or inhibiting cations from passing through. In some embodiments, the anion-selective membrane is anisotropic, e.g., the membrane may preferentially allow anions to pass in certain directions across the membrane. Non-limiting examples of materials that may be used for the anion-selective membrane include various ionomers such as Neosepta®, poly(fluorenyl-co-aryl piperidinium) (PFAP), various polymer electrolytes containing positive tertiary or quaternary ammonium functional groups and mobile anions, block copolymer electrolytes such as poly(arylene ether sulfone) with hydrophilic and hydrophobic segments, polyethylene or polystyrene based multi-block copolymers, or other materials such as any of those described herein. In some embodiments, the block copolymer has at least one positively charged block or segment.

In addition, other separators may be used in certain embodiments, instead of or in addition to anion-selective membranes. In some cases, the separator may be a membrane, for example, a permeable or a semipermeable membrane. The membrane or separator may be relatively permeable to water but impermeable to ions, e.g., charged ions in certain embodiments. In some cases, the membrane or separator may be relatively porous, e.g., having a porosity that allows fluid to flow through the membrane or separator in some cases. In addition, in some cases, the membrane or separator may be functionalized, e.g., with positively charged or negatively charged species. In some cases, separators may comprise polypropylene-based separators (e.g., Celgard), glass fiber, polymer/ceramic composites (e.g., polypropylene and alumina), plastic mesh, virgin wood fiber tissue, or the like. In some cases, a separator is porous enough that it does not fluidically separate the two compartments. In some embodiments, the separator is soft and/or flexible, and/or may be provided with mechanical reinforcement to increase its stiffness. In some cases, reinforcement allows more efficient operation, for example, during both fluid switching and ion extraction steps. For example, this may be achieved by reducing the deformation of the separator into adjacent flow channels, e.g., which may in some embodiments cause undesirable heterogeneities in the fluid flows and/or ion exchange with the electrodes. Non-limiting examples of reinforcement materials for separators or membranes include polymeric fibers or meshes, ceramic particles or powders, nanoparticles, nanotubes, nanoflakes, etc. These may, for example, be integrated into the bulk porous solid, coated on one or both surfaces of the separator or membrane, etc.

In addition, electrodes within the first set of compartments may be connected to electrodes within the second set of compartments, e.g., by an electrical pathway. This can be seen, for example, in FIG. 2 with electrodes 31 within the first set of compartments connected to electrodes 32 within the second set of compartments via electrical pathway 70. In some embodiments, the electrical pathway may be free of a voltage source, e.g., a battery or an external voltage source. Accordingly, electrons can flow from the electrodes within the first set of to the electrodes within the second set of compartments, or vice versa, along the electrical pathway. In addition, in some embodiments, a load (or external resistance) may also be present within the electrical pathway, e.g., such that power can be generated from the apparatus as electrons flow from one set of electrodes to the other.

Without wishing to be bound by any theory, it is noted that because the first fluid may contain a higher concentration of ions (e.g., lithium ions, chloride ions, etc.) than the second fluid, this may cause a voltage gradient to develop, e.g., spontaneously, between the first fluid and the second fluid. The spontaneous voltage may exist under open circuit conditions. In some cases, spontaneous voltage may arise from reverse electrodialysis, corresponding to the Donnan potential which may result from the difference in counter-ion concentrations across the counterion-selective membrane separating the two fluids. In some cases, spontaneous voltage may arise from concentration polarization and may correspond to the difference in Nernst half-cell potentials at the two target-ion selective electrodes, e.g., as a result of the different concentrations of target ions in the two fluids. In addition, in some cases, both of these effects and/or other effects may cause a spontaneous voltage to exist under open circuit conditions. This spontaneous voltage can be used, in some cases, to drive the processes by which lithium ions may be incorporated in or removed from the lithium-selective electrodes. In particular, due to the presence of the anion-selective membrane, anions (such as chloride) may pass from the first set of compartments (e.g., containing a first fluid rich in lithium ions, and counterions such as chloride) to the second set of compartments (e.g., containing the second fluid).

However, while anions are able to pass through the anion-selective membrane, lithium ions (or other cations) within the first set of compartments are not able to easily pass through the membrane. Instead, the lithium ions may become incorporated into the lithium-selective electrode, e.g., by effects such as intercalation, electrosorpotion, deposition or electrodeposition, e.g., in combination with electron transfer from the electrical pathway to reduce a host material (e.g., lithium), as the anions leave the first set of compartments (Li⁺+e⁻→Li). As the lithium-selective electrode is selective to lithium, rather than to other co-ions such as sodium, calcium, magnesium, etc., lithium may be preferentially incorporated into the lithium-selective electrode, while the other co-ions pass by the electrode and exit the first set of compartments.

In the second set of compartments, the anions enter across the anion-selective membrane, while lithium ions are created from lithium previously incorporated in the lithium-selective electrode and released into solution, while creating an electron which can then flow via the electrical pathway into the first set of compartments (Li→Li⁺+e⁻). The lithium ions and the anions thus enter the second fluid contained within the second set of compartments. In this way, the second fluid becomes enriched in lithium ions, without necessarily including other contaminating co-ions such as sodium or other cations described herein. The second fluid can then be used for a variety of purposes, e.g., as a source of purified lithium ions.

As a non-limiting example, in certain embodiments, at a first point in time, a first fluid (e.g., a lithium-rich fluid) from a first source of fluid 51 passes through a first set of compartments 21, while a second fluid (e.g., a lithium-poor fluid) from a second source of fluid 52 passes through a second set of compartments 22, as is shown in FIG. 2A. In the first set of compartments, the lithium incorporates (e.g., deposits) into a first set of lithium-selective electrodes 31 by combination of the lithium ions with an electron from the electrical pathway and anions exit through the anion-selective membrane, while in the second set of compartments, anions flow in through the anion-selective membrane and lithium ions are created from lithium incorporated into the second set of lithium-selective electrodes 32, thereby freeing an electron that flows through the electrical pathway into the first set of compartments.

However, at a second point in time, the first and second fluids are switched by action of the flow-switching element, as is shown in FIG. 2B. As is shown in this figure, fluid from the first source of fluid 51 now passes through the second set of compartments 22, while fluid from the second source of fluid 52 now passes through the first set of compartments 21. In the first set of compartments, the lithium that was previously incorporated into the first set of electrodes 31 can now be removed as lithium ions into the second fluid (e.g., a lithium-poor fluid) as anions also enter across the anion-selective membrane, while in the second set of compartments 22, lithium ions are now able to incorporate into the second set of electrodes 31 (now more depleted of lithium) as anions leave across the anion-selective membrane to reach the first set of compartments. Accordingly, this may be thought of as a “mirror image” of the process shown in FIG. 2A.

This process may be repeated any suitable number of times, e.g., resulting in a second fluid that becomes enriched in lithium ions after passing through the apparatus, while the first fluid accordingly becomes more depleted in lithium ions. The repetition may occur on a periodic or regular basis, or the repetition may occur on an aperiodic or irregular basis in some embodiments. The second fluid can be used for a variety of purposes, e.g., for the production of lithium batteries as a source of lithium, or for other applications. In addition, in certain embodiments, one or both sets of compartments may be “flushed” between switches, e.g., with a different fluid, and/or by rejecting some of the fluid initially passing through the compartments after a switch occurs.

In some cases, the flushing or rinse fluid may be chosen to be the same as the fluid most recently introduced into the compartment, although in some cases, the fluid may be a different fluid. For example, additional recovery fluid may be used to flush the recovery compartment after lithium (or other target ion) release from the contacting electrode. The duration and flow rate of a flushing step may be controlled to increase the recovery of additional target ions while minimizing dilution of the recovery fluid. In some embodiments, at least one of the rinse fluids is a gas. In some cases, the pressure or temperature of the rinse fluid may be elevated. For example, the pressure (gauge pressure) may be at least 50 kPa, at least 100 kPa, at least 200 kPa, at least 300 kPa, at least 1 MPa, at least 2 MPa, at least 5 MPa, at least 10 MPa, at least 20 MPa, etc. The temperature may be, in some embodiments, at least 30° C., at least 40° C., at least 50° C., at least 60° C., at least 70° C., at least 80° C., at least 90° C., etc. In some cases, the temperature may be no more than 100° C., no more than 90° C., no more than 80° C., no more than 70° C., no more than 60° C., no more than 50° C., no more than 40° C., no more than 30° C., etc. In addition, combinations of any of these are also possible. This may, in certain embodiments, may improve flushing and reduce the retained volume of the original fluid in the flow channels and electrodes.

In one set of embodiments, whenever fluids are switched in a given compartment, fluid mixing may be reduced. Without wishing to be bound by any theory, fluid mixing may be dominated by convection and associated hydrodynamic dispersion. Converging flow fields, e.g., in radial inward flow geometries, may be designed in certain embodiments to limit the total volume of the mixing zone. As a non-limiting example, the mixed volume between two miscible fluids in contact with one another can be estimated in some cases as the product of existing cross sectional area between the two fluids and the mixing zone thickness, approximated by sqrt(2 K t), where t is the residence time and K is the hydrodynamic dispersion coefficient for the channel. Enhanced mixing in turbulent flows may be avoided by maintaining a small Reynolds number in open compartments. Hydrodynamic dispersion may be limited, for example, by reducing the flow rate during fluid switching, by modifying the microstructure to reduce the sizes or thicknesses of channels and/or pores and/or loops in the pore network, etc.

In one set of embodiments, mixing of fluids can occur during fluid switching, for example, when a first fluid (e.g., a target ion-rich fluid) is switched with a second fluid (e.g., a target ion-poor fluid). Mixing can occur, for example, as a result of interfacial instability and/or inter-diffusion of the two fluids, hydrodynamic dispersion of suspended particles or ions between the two fluids, and/or incomplete fluid switching, e.g., as result of retained fluid volume, including any fluid trapped within porous electrodes, in residual coatings on the surfaces of the electrodes, flow chambers, tubes, valves, etc. Accordingly, in some embodiments, a rinse fluid may be added to separate the first fluid and the second fluid. For instance, a first fluid may be passed through a compartment, followed by a rinse fluid, followed by a second fluid. In some cases, the second fluid may be followed by a second rinse fluid (which may be the same or different from the rinse fluid), followed by the first fluid or a third fluid, etc. The rinse fluid may be, for example, a liquid (e.g., water, an oil, solvent, etc., or other fluids such as those described herein), or a gas (e.g., air, compressed air, water vapor, carbon dioxide, nitrogen, or other fluids such as those described herein).

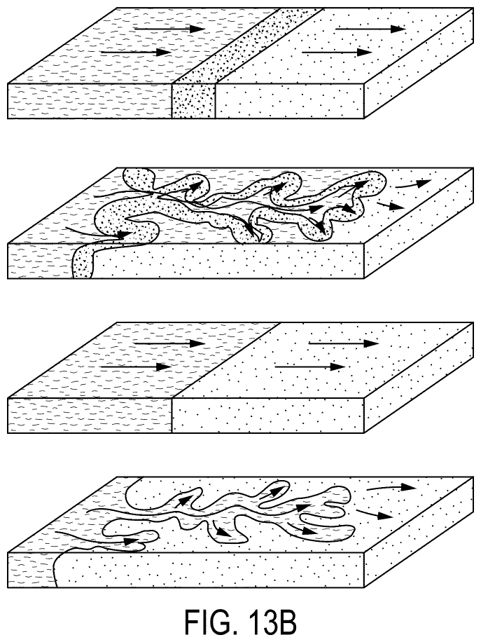

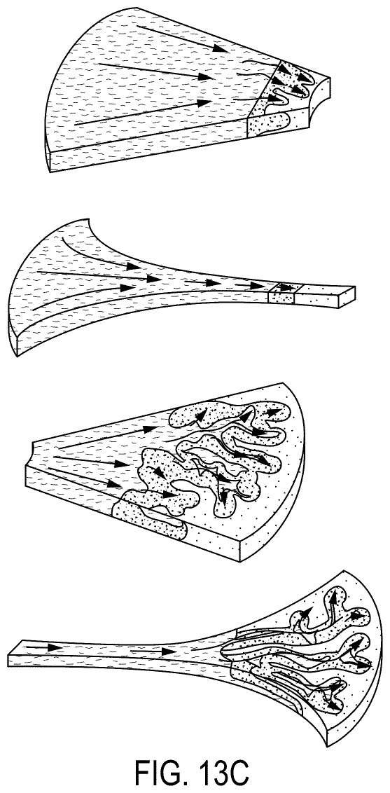

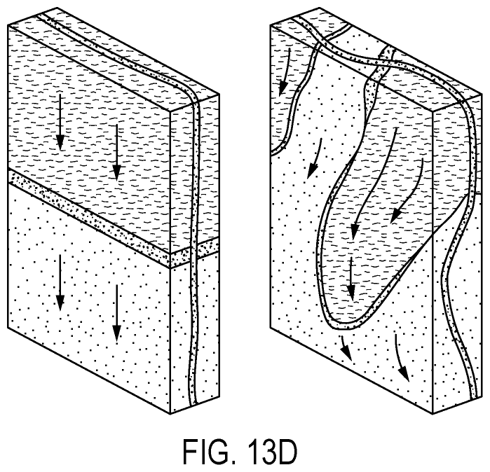

In another set of embodiments, interfacial mixing within a compartment may be reduced by employing a converging flow field. For instance, in a converging flow field, the mean velocity at an outlet may be greater than the mean velocity at an inlet of a compartment. In some cases, a converging flow may reduce the mixing of fluids by hydrodynamic dispersion (FIG. 13A) or by miscible or immiscible viscous fingering (FIG. 13B).

FIG. 13A shows a mixing zone (8) between a first fluid (fluid 1) and a second fluid (fluid 2) in a straight channel, where a second fluid follows a first fluid through a channel.

The fluids may mix via diffusion and/or hydrodynamic dispersion, in this example. FIG. 13B illustrates miscible fluids (upper figures) or immiscible fluids (lower figures) flowing through a channel, where a second fluid follows a first fluid, may mix via a variety of mechanisms, e.g., depending on their viscosities. Either fluid may have a higher viscosity. In some cases, a stable interface may be created between a first fluid and a second fluid (for example, if the second fluid has a higher viscosity), although in other cases, the interface may be unstable (for example, if the second fluid has a lower viscosity), and viscous fingering or Saffman-Taylor instabilities may be present between the two fluids.

A variety of techniques can be used to produce a converging flow field. For example, in some embodiments, an inlet of a compartment may have an area greater than an area of an outlet, e.g., resulting in a generally converging flow field towards the direction of the outlet. Non-limiting examples are shown in FIG. 13C (upper figures). In some embodiments, the cross-sectional area of a flow channel may decrease continuously in the direction of the mean flow. In some embodiments, the cross-sectional area may change abruptly, e.g., by a step change in the width, height or radius of a flow channel. In some cases, for instance, fluid may flow through a wedge or a circular arc towards an outlet, or an outlet may be positioned in a central location of a compartment. In some cases, a compartment may have a spiral configuration that causes convergence of the flow. However, it should be understood that in other embodiments, the flow need not be convergent, and may be divergent in some cases, e.g., as is shown in FIG. 13C (lower figures).

In some embodiments, without wishing to be bound by any theory, fluid mixing may be enhanced by hydrodynamic instabilities, e.g., driven by property differences between the fluids being switched. In some cases, whenever a fluid of higher viscosity displaces another of lower viscosity, or more generally when the viscosity gradient opposes the pressure gradient, the Saffman-Taylor instability may lead to the growth of viscous fingers into branched tree-like structures. For two miscible fluids, viscous fingering may amplify mixing by convectively stretching and folding the miscible fluid interface, as it spreads by diffusion and hydrodynamic dispersion. For immiscible fluids, viscous fingers may stretch, undergo Rayleigh-Plateau instability, and pinch off to form droplets and rivulets, often pinned near corners, pores or protrusions in the surfaces of the flow channel. In some embodiments, for example, viscous fingering may be limited by reducing viscosity gradients, e.g. by varying temperature or fluid composition (as noted above); by reducing the pressure gradient, e.g. by slowing down the flow or expanding the channel thickness in the flow direction; by applying electric fields, e.g. to leverage electro-osmotic flows to reduce the pressure gradient; and/or by introducing soft, elastic, or deformable surfaces on the walls, such as polymeric membranes or separators, in some cases to suppress the instability.

In some embodiments, density differences may influence fluid mixing by enhancing or suppressing a variety of hydrodynamic instabilities. For instance, the buoyancy-driven Rayleigh-Taylor instability may occur whenever the fluid density gradient opposes the pressure gradient, e.g., if a more dense fluid is present above a less dense fluid. For immiscible fluids, instability may stretch or fold the interface, and may promote droplet breakup and retention in certain embodiments. For miscible fluids, the instability may lead to vortices of Rayleigh-Benard convection in some cases, which may be used to enhance mixing and enlarge the mixed volume. These instabilities may be limited in some cases by maintaining a small Rayleigh number, for example, by controlling the density gradient and length scale for convection. For certain fluids, if the density gradient is parallel to a viscosity gradient, then stable stratification, e.g., where a less dense fluid is present above a more dense fluid, may suppress viscous fingering, while unstable stratification, e.g., more dense over less dense, may enhance viscous fingering. If, in some embodiments, the density gradient is perpendicular to the pressure gradient and heavier and lighter fluids move at different mean velocities, then shear stresses at the interface may also cause Kelvin-Holmholtz instability in some embodiments. This may be helpful to cause vortices that may enhance mixing. The Kelvin-Helmholtz instability may be limited in certain embodiments, for example, by maintaining a small Richardson number, increasing surface tension (for immiscible fluids), and/or designing the flow geometry to have smoothly varying cross sections that promote more uniform flow without sharp corners or turns, etc.

In some embodiments, two or more adjacent parallel flows in the stack may be separated by solid boundaries, such as an ion exchange membranes or separators. In some cases, a boundary may be defined by a material that is soft, flexible, permeable, and/or deformable, for instance, under the application of fluid within the parallel flow. In some embodiments, there may be elasto-hydrodynamic, fluid-structure, and or poromechanical interactions between flows in adjacent channels, which may in certain cases influence fluid mixing by amplifying fingers and regions of fluid trapping, e.g., as shown in FIG. 13D. In this figure, fluid switching in parallel flow channels may be separated by a relatively rigid boundary (left) and a deformable boundary (right). The deformable boundary may allow fingering instability or mixing to occur.

In galvanic ion extraction, as a non-limiting example, an anion exchange membrane may form a boundary between two flow channels over the electrodes. In some embodiments, there may be more than one membrane and/or separator, e.g., that define multiple flow channels separated by boundaries, e.g., soft, flexible, permeable, and/or deformable boundaries, etc. In certain embodiments, fluid switching may be done sequentially, serially, or at the same time with flows in the same or different directions.

In some cases, boundaries may undergo wrinkling instabilities coupled with the Saffman-Taylor, Rayleigh-Taylor, and Kelvin-Helmholtz hydrodynamic instabilities, which may in some embodiments cause fluid fingers and vortices to alternate positions in adjacent channels across the boundary. In some embodiments, fluid droplets or bubbles may become trapped in the flow channel, for example, in constrictions formed by bounadries such as wrinkled flexible boundaries. In some cases, fluid-structure interactions such as these may be limited by reinforcing the boundaries with mechanical additives, such as fibers, polymer meshes, or ceramic particles, by co-flowing fluids in adjacent channels with nearly identical flow fields, by eliminating membranes and separators, e.g., in certain ion extraction processes such as electrochemical ion exchange. Instabilities and trapped fluid can also be limited in some embodiments, for example, by reducing the permeability of boundaries to fluid flow, which may otherwise re-distribute fluid across the boundary and amplify heterogeneities in fluid density between adjacent channels. In some cases, the boundaries may be soft, flexible, permeable, and/or deformable, etc.

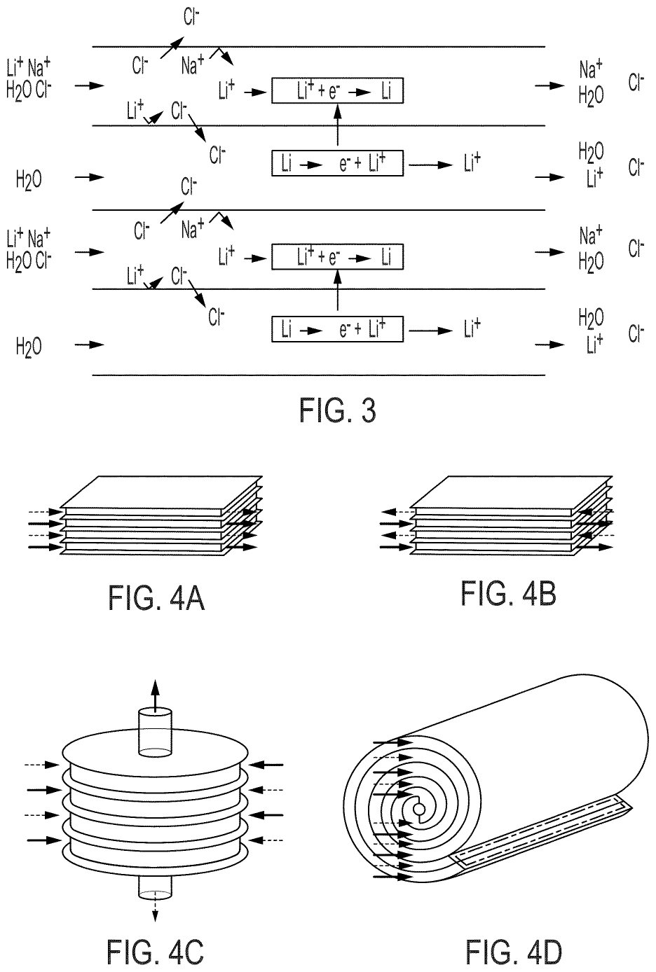

FIG. 3 illustrates the flow of various ions through a stack in accordance with one embodiment. A lithium-rich fluid may contain ions such as Li⁺, Cl⁻, Na⁺, etc., while a lithium-poor fluid may be mostly water (H₂O), or other fluids. Anions such as Cl⁻ are able to exit the lithium-rich fluid across anion exchange membranes into the lithium-poor fluid, while cations such as Na⁺ and Li⁺ cannot. At the lithium-selective electrode in the lithium rich fluid, the lithium ions can selectively combine with electrons to incorporate lithium in the lithium-selective electrode, e.g., by lithium ion intercalation or by lithium metal electrodeposition through a lithium-selective membrane. Na⁺ is much less likely to be incorporated into the lithium-selective electrode, and thus exits the stack. In contrast, in the lithium-poor fluid, anions such as Cl⁻ enter lithium-rich fluid across anion exchange membranes. At the lithium-selective electrode within the lithium-poor fluid, lithium is converted into lithium ions (Li⁺) and electrons, which can then flow through an electrical pathway to the lithium-selective electrode in the lithium-rich fluid. In addition, it should be noted that the fluids may be switched, as noted above, which causes the alternating lithium-selective electrodes to switch roles: for the lithium-selective electrodes formerly in the lithium-rich fluids, the incorporated lithium can now be removed into the lithium poor-fluid as lithium ions, while the lithium-selective electrodes formerly in the lithium-poor fluids can now become a site for incorporating lithium from the lithium-rich fluid.

In some embodiments, the apparatus may be run such that electrons flow spontaneously from the electrodes in the lithium-poor fluid to the electrodes in the lithium-rich fluid or current flows spontaneously from the electrodes in the lithium-rich fluid to the electrodes in the lithium-poor fluid, for example, without imposing an external potential, e.g., using a voltage source, to cause the electron flow to occur. As noted above, the spontaneous flow of current can be harnessed to produce useful work, i.e., the apparatus may produce electricity during operation under certain conditions. This mode of operation can be thought of as a galvanic process, similar to the discharging step of a battery. The switching of fluids may allow for galvanic operation by driving electrons in the opposite direction, as the two electrodes switch their roles as anode and cathode. In some cases, the galvanic ion extraction process can produce energy, e.g., continuously, as target ions such as lithium are extracted.

However, it should be understood that other modes of operation are possible as well. For example, in some cases, an external potential may be applied between the electrodes in the lithium-poor fluid to the electrodes in the lithium-rich fluid. This may, in some cases, be used to slow down or speed up the extraction process, e.g., depending on the particular application, compared to its passive spontaneous rate for a given external load. In some cases, this may facilitate the flow of current from the electrodes in the lithium-rich fluid to the electrodes in the lithium-poor fluid, or facilitate the flow of electrons from the electrodes in the lithium-poor fluid to the electrodes in the lithium-rich fluid, e.g., at currents greater than that which would be created due to spontaneous current flow. In some cases, this may increase the rate of lithium extraction within the stack, and in certain embodiments, while maintaining a positive voltage of the same sign as the open circuit voltage (e.g., at zero current). Such operation can be thought of as a supergalvanic process. In some embodiments, the rate of lithium extraction may be accelerated in the direction of positive current past the point where the voltage switches sign during operation. Without wishing to be bound by any theory, it should be understood that a supergalvanic process differs from an electrolytic process, which involves driving a negative current in reverse from its spontaneous direction by the additional electrical energy, while maintaining a positive voltage. As such, galvanic ion extraction is different from electrolytic metal extraction processes, even when operated at high rates in supergalvanic mode.

In some cases, current may optionally be applied to force galvanic ion extraction to proceed more rapidly than the spontaneous rate in the absence the applied potential, but in the same direction, via the same steps. This accelerated operating mode may be supergalvanic, since the system acts as a supergalvanic cell. It should be understood that the system does not act as an electrolytic cell, where the current is forced to flow in a non-spontaneous direction by an external voltage source. Supergalvanic ion extraction thus differs fundamentally from electrolytic extraction. In some embodiments, supergalvanic ion extraction is more energy efficient than electrolytic ion extraction. In some cases, the device can be operated at lower electrical power consumption, including zero power consumption, which is not possible for electrolytic cells. A simple test to determine whether an electrochemical ion extraction process is electrolytic or supergalvanic is to remove all external voltage sources and set the electrical power consumption to zero, in which case an electrolytic ion extraction process would cease to function and no longer extraction ions, while a supergalvanic ion extraction process would continue to function and extract ions spontaneously, as a galvanic ion extraction system.

In addition, in some cases, an external potential may be applied in the opposite direction, e.g., to at least partially slow the flow of current from the electrodes in the lithium-rich fluid to the electrodes in the lithium-poor fluid or the flow of electrons from the electrodes in the lithium-poor fluid to the electrodes in the lithium-rich fluid. This may be useful in certain embodiments, for example, to control the rate at which lithium is extracted by the lithium-selective electrodes within the stack, e.g., relative to short circuit conditions with zero external resistance, which may correspond to the maximum rate of galvanic discharge for a given system as set by its internal resistance.

It should be noted that while lithium was used in the above non-limiting example, the present disclosure herein is not so limited, and that in other embodiments, other target ions instead of or in addition to lithium may be separated, e.g., using an apparatus as described herein. Examples of such ions include sodium, potassium, copper, gold, silver, magnesium, calcium, nickel, manganese, cobalt, chloride, sulfate, nitrate, hydroxide, heavy metals, transition metals, rare earth elements, lanthanides, actinides, or other ions described below. Accordingly, more generally, various aspects as described herein are directed to various apparatuses and methods for the extraction of ions.

The apparatus may be used in one aspect to purify a fluid rich in a target ion, such as a target cation or a target anion. As mentioned, in one set of embodiments, the target ion may be lithium. Examples of lithium-rich fluids in which it may be desired to extract the lithium include, but are not limited to, water from naturally occurring or artificially produced brines, for example, salt-lake brines, geothermal brines, artificial desalination brines, water from hydraulic fracturing, brackish water, underground water, or seawater. In some cases, such water may contain high concentrations of sodium, potassium, calcium, magnesium, and/or other competing ions which differ from the target ions. As another example, the lithium-rich fluid may be a leachate, such as an acidic or basic leachate or other leach liquor. The leachate may be a leachate from, for example, hard-rock mining, lithium metal recycling, lithium-ion battery recycling, or the like. Examples of hard rocks containing lithium include spodumene or eucryptite, which may be crushed and processed in some cases by hydrometallurgical methods to dissolve lithium and other ions in a leachate. Still other non-limiting examples include water produced from oil or gas extraction (e.g., water produced by hydraulic fracturing), nuclear plant cooling or cleaning water, reverse-osmosis or other desalination processes, or other water treatment processes.

However, as mentioned, in other embodiments, other target ions may be extracted, instead of or in addition to lithium. For example, the target ion may be a metal ion, e.g., another dissolved metal cation. Non-limiting examples include sodium, potassium, silver, gold, copper, iron, aluminum, mercury, cadmium, chromium, arsenic, manganese, cobalt, nickel, other transition metals, lanthanum, ytterbium, cerium, neodymium and other lanthanides, yttrium, actinium, thorium, uranium, plutonium, and other actinides, etc. In certain cases, the target ion may be an anion, such as chloride, sulfate, nitrate, or hydroxide, or ionic complexes of the metal cations listed above, such as heavy metal oxyanions (e.g., arsenate, chromate, ferricyanide, etc.) or the like, which can be extracted using a suitable electrode selective to the target ion, as discussed herein. In some cases, more than one target ion can be extracted in an apparatus, for example, by using a first electrode within a compartment that is selective to a first target ion, and a second electrode within the compartment that is selective to a second target ion, thereby allowing the different target ions to be incorporated (e.g., deposited, intercalated, etc.) into and/or removed from the different electrodes.

In some cases, the target ion may be dissolved in an aqueous solution. For example, the aqueous solution may be seawater, brackish water, underground water, geothermal water, brines, leachates from mining operations, water produced from oil or gas extraction, or the like, including any of the sources of water previously described above. As a non-limiting example, in one set of embodiments, the first fluid rich in the target ion may be obtained by passing water or aqueous solutions across ores or rocks rich in one or more target ions, which may allow such ions to leach out of the ores or rocks. As another example, the water or aqueous solution may be obtained by passing water or aqueous solution across electrical components (e.g., semiconductor chips) to leach out such ions. As other examples, the water or aqueous solution may be obtained as a leachate from metal scrap, e-waste, or battery recycling, etc. In certain cases, such processes may be facilitated by elevating or lowering the temperature, mechanical operations (crushing, grinding, shredding, pulverizing, etc.), or the like.

In some embodiments, the target ion may be dissolved in a non-aqueous solution. As a non-limiting example, in one set of embodiments, the target ion is lithium, and the first fluid rich in the target ion is a Li-ion battery electrolyte, containing an organic solvent, such as ethylene carbonate, ethyl-methyl or di-methyl carbonate, a dissolved lithium salt as well as possible contaminants. In some embodiments, the organic Li-ion battery electrolyte is obtained from aged Li-ion batteries, and galvanic lithium extraction is performed during battery recycling.

In certain embodiments, the lithium (or other target ions) may be present in the fluid at a concentration of at least 0.01 mol %, at least 0.02 mol %, at least 0.03 mol %, at least 0.05 mol %, at least 0.1 mol %, at least 0.2 mol %, at least 0.3 mol %, at least 0.5 mol %, at least 1 mol %, at least 2 mol %, at least 3 mol %, at least 5 mol %, at least 10 mol %, etc. of the target ion. Other concentrations are also possible in other embodiments. In some cases, the concentration of lithium (or other target ions) may not be known.

In one set of embodiments, the target ions (for example, lithium, copper, gold, silver, chloride, hydroxide, etc. etc.) may be extracted into a second or recovery fluid, e.g., one that is free of the target ion, or at least one that is relatively poor or has a lower concentration of the target ion than the fluid rich in a target ion.

As a non-limiting example, for lithium ion extraction, the second fluid may be a lithium-poor fluid, e.g., one that has a relatively low concentration of lithium ions (or is substantially free of lithium ions). For example, the lithium-poor fluid may have a concentration of lithium of no more than 0.01 mol %. Non-limiting examples of such fluids include fresh water (e.g., naturally-occurring fresh water), purified water, distilled water, desalinated water, municipal water, or the like.

The second (or recovery) fluid can then be used for a variety of applications, e.g., using the extracted lithium (or other target ion). The second fluid may have a concentration of the target ion of less than 0.01 mol %. In some cases, for lithium, the lithium may be available within the second fluid as a lithium hydroxide solution, a lithium chloride solution, a lithium carbonate solution, or the like. In some embodiments, the second fluid can be directly used as a source of lithium for the direct manufacture of lithium batteries, e.g., without requiring subsequent processing, purification, crystallization, or the like. However, in other cases, the second fluid may be processed, for example, using subsequent steps such as reverse osmosis, evaporation, precipitation, or the like to concentrate the lithium (or other target ions).

In certain aspects, an apparatus as discussed herein can include a plurality or “stack” of compartments, through which fluids can flow. The compartments may be of the same or different sizes. The compartments can be formed using metals, plastics, ceramics, or other suitable materials. In some cases, some or all of the compartments may be lined or coated with a plastic, e.g., a substantially water-resistant plastic, a hydrophobic plastic, or the like. The fluid compartments may also be filled with and/or supported by a porous plastic or other permeable material, e.g., which may promote mixing by hydrodynamic dispersion during ion extraction.

The compartments may be of any size, and different compartments may independently be of the same or different sizes. For example, a compartment may have a volume of at least 0.1 m³, at least 0.3 m³, at least 0.5 m³, at least 1 m³, at least 3 m³, at least 5 m³, at least 10 m³, etc. The compartments may also have any suitable shape, including cylindrical or rectangular. In one set of embodiments, for instance, the compartments may have opposed or parallel surfaces, for example, that adjoin neighboring compartments. In some cases, the surfaces may include a membrane, such as a selective ion exchange membrane, e.g., as described herein.

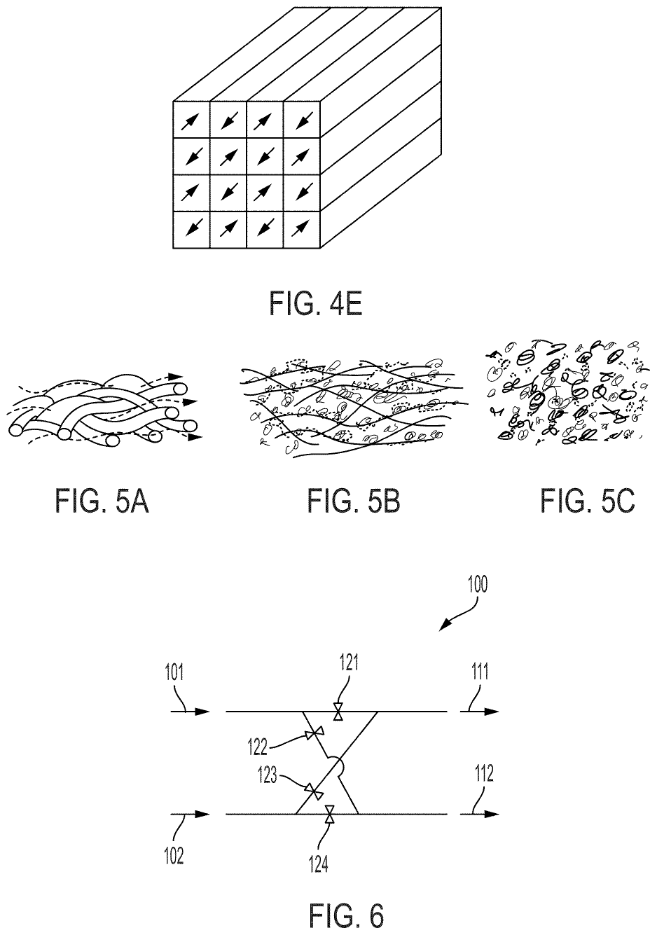

However, it should be understood that in some embodiments, non-rectangular stacks or non-rectangular compartments may be used. For instance, the stack may be cylindrical, for example, with inward or outward radial flow between parallel circular annular electrodes and membranes (or other separators). Such a configuration may be useful, for example, for reducing mixing by hydrodynamic dispersion during ion exchange. In some embodiments, the stack is rolled or has spiral-wound cylindrical shape, optionally with either normal or parallel flow through the electrodes, e.g., as described herein. Flows in such cylindrical stacks may be radially and/or axially directed in some embodiments. In some embodiments, a rectangular or non-rectangular stack may be oriented vertically with lighter fluids introduced above heavier fluids, for example, in order to reduce mixing by buoyancy-driven convection. Non-limiting examples of rectangular stacks are shown in FIGS. 4A and 4B, while examples of cylindrical stacks are shown in FIGS. 4C and 4D.

The flows of fluid within adjacent compartments may be parallel, anti-parallel, orthogonal, or at any other suitable angles. In some case, the flows may be skewed or bidirectional. In some cases, the flow of fluid may be perpendicular to each other. In addition, in some cases, there may be serpentine flows of fluid between different compartments. The fluid may also flow around and/or through the electrodes (e.g., using flow-through electrodes).

The compartments may be open or closed in some embodiments. In some cases, gaskets or spacers may be present. In some embodiments, the compartments may contain inert or porous materials, for example, glass fabrics or mats (e.g., coated with PTFE), electrospun or extruded fibrous polymeric materials, packed beds of beads (e.g., glass, ceramic, plastic, etc.), or the like. The flow of fluid through the fluids through the compartments may be in any suitable orientation, e.g., vertical, horizontal, etc. As an example, some or all of the compartments may be oriented vertically in one embodiment, e.g., to allow precipitates to fall through the compartments, e.g., for collection.

In some cases, the compartments define a “repeat unit” that is repeated throughout the entire stack, in which some or all of the repeat units are nearly identical. There may be any number of repeat units within the stack. For instance, a stack may contain at least 2, at least 4, at least 5, at least 10, at least 15, at least 20, at least 25, at least 30, at least 40, at least 50, at least 60, at least 75, at least 100, etc. repeat units. In addition, the repeat units may extend in two dimensions, or three dimensions in some cases. For example, in FIG. 4E, a stack comprises a plurality of repeat units that extend in two dimensions. In some cases, the repeat units at the ends of a stack may be different than the internal repeat units, for example, ending with different electrodes or flow channel geometries.

In some cases, the use of stacks may allow a given compartment (e.g., one containing a lithium-rich fluid) to access more than one compartment across more than one multiple anion-exchange membrane. For example, a given compartment may have access to two, three, four, or more other compartments via anion-exchange membrane positioned between the given compartment and the adjacent compartments. This may improve the efficiency of separation in some cases, for example, due to the increased ability for anions to exit across the anion-exchange membranes, e.g., due to the increased available surface area for anionic transport to occur.

In one aspect, the compartments may include one or more lithium-selective electrodes. As discussed, the lithium-selective electrodes may preferentially allow lithium to be incorporated (e.g., deposited, intercalated, etc.) or removed therefrom, relative to other co-ions (e.g., cations or positively charged ions) such as sodium, calcium, magnesium, or other competing ions. The lithium-selective electrode may comprise an active material such as an active battery cathode material. The active material, in one set of embodiments, can be a material that is selective for reaction with lithium ions versus other competing co-ions. Thus, for example, the active material may be a material that preferentially reacts with lithium ions in solution, e.g., such that the lithium ions can be incorporated into the electrode due to such reaction. The incorporation may occur by ion intercalation, electrosorption, electrodeposition, or the like, as well as combinations of these and/or other processes in certain embodiments. In some cases, this reaction may be reversible, e.g., such that the incorporated lithium can be released from the active material to enter solution as lithium ions.

In some cases, the active material may be material that forms a lithium salt, reduced lithium metal, and/or a material that intercalates lithium ions as compensating electrons reduce the host material. The active material may be, for example, a lithium-ion battery active material, such as a lithium-ion intercalation material. In addition, in some cases, more than one such active material may be present, including any one or more of the active materials described herein, and/or other active materials.

For instance, in one embodiment, the active material may comprise a lithium metal phosphate, LiMePO₄, where Me can be a transition metal such as iron (e.g., lithium iron phosphate, LiFePO₄ or LFP), titanium (e.g., lithium titanium phosphate, LiTi₂(PO₄)₃ or LTP), manganese, nickel, cobalt, or the like, or a mixture of transition metals such as manganese, iron, cobalt, nickel, etc. (e.g. lithium manganese iron phosphate, LiMnₓFe₁₋ₓPO₄ or LMFP). In some cases, more than one such metal may be present, including these and/or other suitable metals. For example, the active material may include a blend of LTP and LFP, a composition comprising lithium iron titanium phosphate, other blends, or the like. In some embodiments, smaller quantities of metals, for example, transition metals such as manganese or nickel, may be present, e.g., within the active material, for example, lithium manganese nickel phosphate, LiFe_{1-x-y}MnₓNi_{y}PO₄, where x and y are each independently less than 1.

In some cases, the active material may include a lithium transition-metal oxide, LiMeO₂, where Me can be a transition metal. Non-limiting examples include manganese (e.g., lithium manganese oxide, LiMnO₂ or LMO), nickel (e.g., lithium nickel oxide, LiNiO₂ or LNO), cobalt (e.g., lithium cobalt oxide, LiCoO₂ or LCO), or the like. More than one transition metal may be present in some embodiments, e.g., as combinations or stochiometric blends. As non-limiting examples, the active material may include a combination of LiMnO₂ and LiNiO₂, or a composition comprising Li(MnₓNi₁₋ₓ)O₂, or the like.

In another example, the active material may include lithium titanate, Li₂TiO₃ and/or Li₄Ti₅O₁₂ (LTO), optionally with coatings such as LiTiO₂, or other coatings such as any of those described herein. Still other non-limiting examples of lithium-ion intercalation material include nickel manganese cobalt oxide (NMC) or nickel cobalt aluminum oxide (NCA).

In yet another example, the active material may be a solid metal. Examples include, but are not limited to, lithium metal, which may be coated with a lithium-selective solid electrolyte membrane material, such as a lithium superionic conductor (LISICON). In some embodiments, in order to avoid chemical reduction of Ti(IV) in LISICON or other degradation phenomena in contact with the aqueous brine, a buffer coating such as lithium phosphorous oxynitride (LiPON) may also be applied. Other non-limiting examples of membrane materials include lithium aluminum titanium phosphate, lithium superionic conductors, LiPON, lithium lanthanum zirconium oxide, solid polymer electrolytes, etc.

In still another example, active material may comprise a lithium-ion intercalation material. Non-limiting examples of lithium-ion intercalation material comprises lithium titanium phosphate (LTP), lithium manganese oxide (LMO), nickel manganese cobalt oxide (NMC), nickel cobalt aluminum oxide (NCA), lithium cobalt oxide (LCO), lithium iron phosphate (LFP), lithium manganese iron phosphate (LMFP), lithium titanium oxide (LTO), disordered rock salt (DRX), graphite, graphene oxide, hard carbon, a carbon ionomer composite, functionalized carbon, or the like.

However, in one set of embodiments, electrodes selective to other target ions (e.g., cations other than lithium ions) may be used, e.g., if the target ion to be extracted is not lithium. In some embodiments, the electrodes may include active materials, such as Prussian blue (Fe₄[Fe(CN)₆]₃), Prussian blue analogues (e.g., nickel hexacyanoferrate, Ni₂FE(CN)₆), Prussian white (Na₂Fe₂(CN)₆), Prussian white analogues (e.g., nickel hexacyanoferrate, Na₂NiFe(CN)₆, manganese hexanoferrate (Na₂MnFe(CN)₆), sodium manganese oxide (Na₂Mn₅O₁₀), titanium disulfide (TiS₂), etc. may be used to selectively intercalate sodium or potassium, etc. In another set of embodiments, the electrodes may be selective to multivalent target ions, such as Mg²⁺ or Ca²⁺, versus monovalent ions, such as Na⁺, Li⁺, and K⁺, e.g., by virtue of a high chemical surface charge in a microporous metallic electrode. Non-limiting examples of such multivalent-ion-selective electrodes include sulfonated porous carbons, vanadium oxide, Prussian Blue analogues, molybdenum sulfides, molybdenum oxides, manganese oxides, manganese/iron/cobalt silicates, vanadium phosphates, Mg metal, Ca metal, Mg/Ca alloys, etc. In some cases, one or more of these materials may be present, e.g., as an intercalant. In yet another embodiment, the active material may comprise a metal oxide, a metal phosphate, a metal-organic framework, a conjugated polymer, and/or a carbonaceous material, etc.

In one set of embodiments, the active material may be present in an electrode at at least 1 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, etc. In some case, the active material may be present at no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 1 wt %, etc. Combinations of any of these are also possible. For example, an active material may be present at a concentration of between 70 wt % and 90 wt %, between 30 wt % and 50 wt %, between 20 wt % and 45 wt %, etc.

In certain embodiments, an active material may be present in the electrode at at least 1 mg/cm² of surface. In some cases, the active material may be present at at least 2 mg/cm², at least 3 mg/cm², at least 5 mg/cm², at least 10 mg/cm², at least 15 mg/cm², at least 20 mg/cm², at least 25 mg/cm², at least 30 mg/cm², at least 35 mg/cm², at least 40 mg/cm², at least 45 mg/cm², at least 50 mg/cm², at least 55 mg/cm², at least 60 mg/cm², at least 65 mg/cm², at least 70 mg/cm², at least 75 mg/cm², at least 80 mg/cm², at least 85 mg/cm², at least 90 mg/cm², at least 100 mg/cm², at least 110 mg/cm², at least 120 mg/cm², at least 150 mg/cm², at least 200 mg/cm², etc. In some cases, the active material may be present at no more than 200 mg/cm², no more than 150 mg/cm², no more than 120 mg/cm², no more than 110 mg/cm², no more than 100 mg/cm², no more than 90 mg/cm², no more than 85 mg/cm², no more than 80 mg/cm², no more than 75 mg/cm², no more than 70 mg/cm², no more than 65 mg/cm², no more than 60 mg/cm², no more than 55 mg/cm², no more than 50 mg/cm², no more than 45 mg/cm², no more than 40 mg/cm², no more than 35 mg/cm², no more than 30 mg/cm², no more than 25 mg/cm², no more than 20 mg/cm², no more than 15 mg/cm², no more than 10 mg/cm², no more than 5 mg/cm², no more than 3 mg/cm², no more than 2 mg/cm², no more than 1 mg/cm², etc. In addition, combinations of any of these ranges are also possible.

In some cases, an active material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the active material or other component may have a contact angle of between 75° and 90°, between 70° and 100°, between 80° and 100°, etc.

The electrode may have any shape or size, and the electrodes within different compartments may independently have the same or different shapes or sizes, in one set of embodiments. For example, an electrode may be rectangular, cylindrical, toroidal, or spherical, or have other shapes (including regular or irregular shapes). In some cases, the electrode may have a longest dimension that is at least 10 mm, at least 20 mm, at least 30 mm, at least 50 mm, at least 100 mm, at least 200 mm, at least 300 mm, at least 500 mm, at least 1000 mm, etc. In some embodiments, the electrode may have a longest dimension that is no more than 1000 mm, no more than 500 mm, no more than 300 mm, no more than 200 mm, no more than 100 mm, no more than 50 mm, no more than 30 mm, no more than 20 mm, no more than 10 mm, no more than 5 mm, no more than 3 mm, no more than 2 mm, no more than 1 mm, etc. Combinations of any of these ranges are also possible in yet other embodiments. For example, the electrode may have a longest dimension that is between 300 mm and 500 mm, between 500 mm and 1000 mm, between 10 mm and 50 mm, etc.

A compartment may have only a single electrode, or more than one electrode in some cases. If more than one electrode is present, the electrodes may independently have the same or different sizes, shapes, compositions, etc. In addition, as discussed herein, some or all of the compartments within a stack may independently contain one or more electrodes, which may independently have the same or different sizes, shapes, compositions, etc. As an example, in some embodiments, at least 50%, at least 75%, at least 80%, or at least 90% of the electrodes within a stack may be compositionally identical, other than the presence/absence of any incorporated lithium. In some cases, the electrodes within a stack may be connected via electrical pathways in any suitable arrangement, e.g., in any suitable configuration, e.g., in series, in parallel, or in other arrangements. Different groups of electrodes may be present within a stack in some embodiments (e.g., a first group and a second group of electrodes), and the electrodes within a group may independently be connected to each other in the same or different configurations.

In one set of embodiments, the electrode may comprise a coating. The coating may, in some embodiments, partially or completely surrounded an active material, and/or active material may be present in the coating, for example, as a component of the coating. One or more than one coating may be present in some cases. However, it should also be understood that no coating may be present in certain instances. The coating may provide a variety of functions, depending on the embodiment. In some cases, a coating may be used to enhance wettability, increase ionic or electronic conductivity, improve electrochemical stability or the like. For example, in one embodiment, a coating may include a lithium-selective material, which may provide additional lithium selectivity versus competing co-ions, such as sodium. Other ion-selective (e.g., cation-selective) materials can also be used in certain embodiments, e.g., for target ions other than lithium. As another example, a coating may include a hydrophilic coating, which may improve wettability of the electrode. In other embodiments, the coating may include a lyotropic ion, for example, to control fouling, wettability, precipitation, macromolecular interactions.

Non-limiting examples of coating materials include lithium titanium oxide (LiTiO2) or polydopamine. Additional non-limited examples of coating materials include carbon (for example, graphitic carbon, carbon black, graphene oxide, Vulcan carbon, coke, carbon nanotubes, or the like), or conducting polymers (for example, polypyrrole (PPy), polyethylene oxide (PEO), or the like). Still another example includes ceramics. For example, a coating material may include one or more oxides of aluminum (i.e., alumina), silicon, zirconium (i.e., zirconia), niobium, etc. Other examples of ceramics include titania or phosphate or borosilicate glass. Such coating materials, in certain cases, may slow or block the transfer of electrons, metal ions, and/or oxygen.

The coating, if present, may be of any thickness on the electrode. For instance, the coating may have an average thickness on the electrode of at least 0.1 mm, at least 0.2 mm, at least 0.3 mm, at least 0.5 mm, at least 1 mm, at least 2 mm, at least 3 mm, at least 5 mm, at least 10 mm, at least 20 mm, at least 30 mm, at least 50 mm, at least 100 mm, etc. In addition, the coating may cover all, or a portion, of the electrode. For example, in various embodiments, the coating may cover at least 10%, at least 20%, at least 30%, at least 40%, at least 50%, at least 60%, at least 70%, at least 80%, at least 90%, at least 95%, etc. of the electrode.

The electrodes may be porous in one set of embodiments, e.g., formed from a porous conducting material. For example, an electrode may have a porosity that allows a liquid to enter, and/or pass through the pores, for example, in a normal or transverse direction to the current. The porosity may thus allow a liquid to enter the electrodes, thus allowing ions to incorporate and/or be removed from the electrodes, e.g., due to the increased available surface area. For example, the porosity may allow fast mass transfer of ions deep into the electrode materials.

In some cases, an electrode may have a porosity of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, no more than 5%, etc., as determined as a volume fraction of the material forming the electrode. For instance, an electrode may have a porosity of between 20% and 25%, between 10% and 30%, between 35% and 45%, between 30% and 40%, between 25% and 70%, etc., on a volumetric basis. In addition, in some cases, the pores may have an average cross-sectional dimension of less than 1 mm, less than 300 micrometers, less than 100 micrometers, less than 30 micrometers, less than 10 micrometers, less than 3 micrometers, less than 1 micrometer, less than 300 nm, less than 100 nm, less than 30 nm, or less than 10 nm, etc. Porosity can be determined using standard porosimetry techniques (e.g., mercury intrusion porosimetry, cyclic porosimetry, gas absorption techniques, etc.) known to those of ordinary skill in the art.

The porosity within the electrodes may have a variety of configurations. For instance, an electrode may include one or more channels (e.g., “flow-through” channels), through which a fluid can flow through the electrode. See, e.g., U.S. Pat. Apl. Ser. No. 63/513,538, filed Jul. 13, 2023, entitled “Flow Systems and Methods for Membraneless Separation,” incorporated herein by reference in its entirety. As additional examples, an electrode may be fabricated from particles, fibers (which may be woven or non-woven), and/or other materials, e.g., packed into an electrode. For example, particles or fibers of active material (e.g., as discussed herein), inert materials, conducting materials, etc. may be packed together to form an electrode. Due to the shape of the particles, fibers, or other materials, spaces or pores may exist within the electrode, through which a fluid can flow. Non-limiting examples include those shown in FIG. 5, including flow channel geometries (FIG. 5A), fiber geometries (FIG. 5B), and particle geometries (FIG. 5C).

Examples of inert materials include, but are not limited to, glass (e.g., phosphate glass), plastics, ceramics, or the like.

Examples of conducting materials include but are not limited to, carbon particles, e.g., coke particles, carbon black, Vulcan carbon particles, or the like. In one set of embodiments, the conducting material may include a capacitive material. Non-limiting examples of conductive materials include graphite, titanium, activated carbon, sulfonated carbon, or the like. As another example, the conducting material may include a metal (for example, present as a metal powder). Non-limiting examples include titanium, platinum, silver, zirconium, tin, copper, gold, zinc, stainless steel. As yet another example, the conducting material includes glass microspheres, for example, metal coated glass microspheres (such as the metals described herein). In still another example, a conductive material may include a conductive carbon material. Non-limiting examples include carbon black, carbon nanotubes, graphene, graphene oxide, etc. Yet other examples include a conductive polymer. Non-limiting examples of conductive polymers include poly(3,4-ethylenedioxythiophene) polystyrene sulfonate (PEDOT:PSS), polypyrrole, polythiophene, polyaniline (PANI), polythiophene, etc. Still other examples of conducting materials include conductive ceramic. Non-limiting examples of conductive ceramics include indium tin oxide (ITO), niobium titanium oxide (NTO), or the like. In addition, one or more than one conductive material may be present, including any of the conductive materials described herein.

In one set of embodiments, a conducting material may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the conducting material may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a conducting material may be present at a concentration of between 5 wt % and 80 wt %, between 30 wt % and 50 wt %, between 20 wt % and 45 wt %, etc.

In some cases, a conducting material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the electrode or other component may have a contact angle of between 90° and 125°, between 85° and 120°, between 80° and 100°, etc.

In some cases, an electrode may be formed using one or more porogens, which may increase the porosity of the electrodes. In some cases, the porogens can be removed, thereby increasing the porosity of the electrode. For example, an electrode may be fabricated using a porogen such as polythelyene glycol (PEG), for example, PEG-6000. Other examples of porogens include, but are not limited to, sucrose, ammonium carbonate, sodium chloride or other salts, or the like. Still other examples of porogens include chloride salts, sulfate salts, silica, carbonate salts, polystyrene, polyethylene glycol (PEG), polyvinyl pyrrolidone (PVP), polyvinylalcohol (PVA), polymethaacrylate (PMA), polyacrylicacid (PAA), or the like.

Porogens can be subsequently removed, e.g., by heating the electrode to oxidize the porogen, or by adding water to dissolve the porogen. Other methods of introducing porosity into an electrode include laser ablation, additive manufacturing, mechanical patterning, or the like.

In one set of embodiments, the electrode may include an additive, such as a conductivity additive, which can be used to increase conductivity of the electrode. Non-limiting examples of additives include carbon (for example, graphitic carbon, carbon black, graphene oxide, Vulcan carbon, coke, or the like), metals (for example, gold, silver, copper, or the like), etc. In addition, in some embodiments, more than one additive may be present in an electrode.

In some embodiments, the electrode may include an ionically conductive additive. In some embodiments, this may improve the transport of ions through the electrode. In some embodiments, the ionically conductive additive may include perfluorinated hydrocarbon polymers linked to sulfonate groups (trademark name Nafion, Aquivion, etc.), alkali metal salts of polystyrene sulfonate, alkali metal salts of sulfonated poly(ether-etherketone) (SPEEK), alkali metal salts of polyvinylsulfonate, hydrocarbon polymers bearing peralkylated ammonium groups, hydrocarbon polymers bearing peralkylated phosphonium groups, or the like.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In some embodiments the electrode may include a mixed ion-electron conducting (MIEC) additive. In some embodiments, this may improve the transport of both ions and electrons through the electrode. Examples of MIEC additives include, but are not limited to, poly(3,4-ethylenedioxythiophene) polystyrene sulfonate (PEDOT: PSS), or polystyrene sulfonate (cation conducting) with polyaniline, polythiophene, polypyrrole, graphite, graphene oxide, carbon coated garnets, nonstoichiometric oxides and perovskites, strontium titanate, titania, ceria, etc.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In addition, the electrode may include a binder in one set of embodiments. The binder may assist in the formation of the electrode, e.g., to bind together components such as the active material, and other components (if present) such as additives, particles, fibers, conducting materials, inert materials, particles or fibers, etc. In some embodiments, the binder may include one or more polymers. Non-limiting examples of polymers include polyvinylidene fluoride (PVDF), polypyrrole (PPy), polyethylene oxide (PEO), etc. In some cases, the polymer may be a hydrophobic polymer, for example, a hydrophobic polymer that exhibits an air-water contact angle of greater than 90°, greater than 100°, greater than 110°, greater than 120°, greater than 130°, etc., or other contact angles such as any of those described herein. Additional non-limiting examples of hydrophobic polymers include polytetrafluoroethylene (PTFE), fluoroethers, fluorinated ethylene propylene (FEP), silicone, polyvinylidene fluoride (PVDF), polypropylenoe, polystyrene, polyethylene terephthalate (PET), or the like. In some embodiments, silicone or silicone polymers may be used. For example, the silicone polymer may be a cross-linked silicone polymer, and or the silicone or silicone polymer may be infused with silicone oil.

In one set of embodiments, the binder may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the binder may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a binder may be present at a concentration of between 5 wt % and 80 wt %, between 30 wt % and 50 wt %, between 20 wt % and 45 wt %, etc.

In some cases, the binder may exhibit a contact angle (determined with a surface in air and pure water) of at least 30°, at least 40°, at least 50°, at least 60°, at least 70°, at least 75°, at least 80°, at least 85°, at least 90°, at least 95°, at least 100°, at least 105°, at least 110°, at least 115°, at least 120°, etc. In some cases, the binder may exhibit a contact angle of no more than 120°, no more than 115°, no more than 110°, no more than 105°, no more than 100°, no more than 95°, no more than 90°, no more than 85°, no more than 80°, no more than 75°, no more than 70°, no more than 60°, no more than 50°, no more than 40°, etc. In some cases, the binder may exhibit a contact angle that is a combination of any of these.

The electrode may be in contact with a current collector in one aspect. The current collector may collect current (electrons), which may flow from a first set of electrodes within the apparatus to a second set of electrodes, or vice versa, e.g., as discussed herein. In some embodiments, the current collector may include a relatively inert material for the fluids and/or active materials. Non-limiting examples of materials for use as current collectors include carbon, graphite, titanium, aluminum, copper, stainless steel, platinum, metallic/polymer composites, graphite/polymer composites, or the like.

In certain embodiments, the current collector may take the form of a mesh or fibers, e.g., for use in porous electrodes, and/or flow-through electrodes. For instance, the current collector may comprise a metal mesh, a carbon cloth, or the like. The current collector may also be a solid material in some cases.

In some aspects, the apparatus includes one or more membranes separating adjacent compartments within the apparatus, for example, a counterion-selective membrane. In some cases, a membrane may be able to fluidically separate two compartments. As discussed, such membranes may be selected to preferentially allow counterions to flow through, while preventing the target ions, or other ions having the same charge as the target ions, from passing through. For example, if the target ion is lithium or another positively charged ion (e.g., silver, gold, etc.), then the counterion-selective membrane may be an anion-selective membrane that preferentially allows anions to flow through. Conversely, if the target ion is chloride or another negatively charged ion (e.g., sulfate, hydroxide, etc.), then the counterion-selective membrane may be a cation-selective membrane that preferentially allows cations to flow through.

The membranes may be formed from any of a wide variety of materials. As an example, in some instances, the membrane may be formed from a polymer. In some cases, the polymer may be an ionomer. In addition, different membranes within an apparatus may be formed from the same or different materials in certain embodiments. In one set of embodiments, the membrane may comprise a coating on a ceramic substrate (e.g., a porous ceramic substrate) or polymeric substrate, etc. in some cases, the membrane may be positively charged, and/or have at least one positively charged surface.

In some embodiments, the counterion-selective membrane may be made of a polymer, such as a block copolymer, or polymers with other architectures such as grafted, clustered, or comb-shaped polymers, etc. Examples of cation-selective membranes include Nafion™Mor other sulfonated tetrafluoroethylene fluoropolymer-copolymer. A specific example of such a membrane is tetrafluoroethylene-perfluoro-3,6-dioxa-4-methyl-7-octenesulfonic acid copolymer. Examples of an anion-selective membrane include Neosepta® or other grafted polytrimethyl benzylamine or polyvinyl aniline, e.g., on a homogeneous polyethylene backbone. Other examples include poly(fluorenyl-co-aryl piperidinium) (PFAP), polymer electrolytes with positive tertiary or quaternary ammonium functional groups and mobile anions, block copolymer electrolytes such as poly(arylene ether sulfone) with hydrophilic and hydrophobic segments, and polyethylene or polystyrene based multi-block copolymers, etc. Still other examples include alumina or silica, optionally having positively charged polymers or functional groups. In some cases, the alumina or silica may be microporous.

In another embodiment, a counterion-selective membrane may comprise one or more layers of ion exchange resin beads. In yet another embodiment, a counterion-selective membrane may comprise one or more ion-exchange resin wafers. In some cases, such ion exchange resins materials may have relatively low water permeability and/or relatively high conductivity for the counterions. In some cases, the ion exchange resin beads may comprise a counterion-selective polymer, such as those described above. In addition, in certain embodiments, the ion exchange resin beads may comprise polystyrene or polystyrene divinylbenzene backbones crosslinked with an ammonium group, or other exchange resin materials known to those of ordinary skill in the art.

In some aspects, the compartments may be divided into a first group of compartments and a second group of compartments, where the compartments are divided such that some or all of the counterion-selective membranes separates a compartment from the first group and a compartment from the second group. For example, the compartments may be arranged in an alternating manner within the stack, e.g., such that no two compartments from the same group are separated by a counterion-selective membrane.

In one set of embodiments, the groups of compartments may be run in an alternating or “rocking-chair” manner, where at a first point of time, fluid from a first source of fluid passes through the first group of compartments and fluid from a second source of fluid passes through the second group of compartments, and at a second point of time, fluid from the first source of fluid passes through the second group of compartments and fluid from the second source of fluid passes through the first group of compartments. For example, the first fluid may be a lithium-rich fluid or a fluid rich in another target ion, while the second fluid may be a lithium-poor fluid or a fluid poor in the target ion.

In such a system, the same compartment can be used for incorporation of lithium (or other target ions) into an electrode, and for removal of lithium (or other target ions) from the electrode, at different times during use. For example, at a first point of time, a lithium-rich fluid may pass through the compartment and lithium incorporated into the electrode, and at a second point of time, a lithium-poor fluid may pass through the compartment and lithium removed from the electrode. Other target ions may be incorporated or removed, in addition to or instead of lithium, in other embodiments.

The times in which fluid switches occur may be fixed, or may vary. For example, in one set of embodiments, the fluids are switched at a fixed period or frequency. In another set of embodiments, the times the fluids are switched may vary, e.g., in a regular or an irregular pattern. In some cases, the time when the fluids are switched may depend on conditions within the compartments. For example, in certain embodiments, the fluids may be switched when a certain amount of lithium has been incorporated, or when a certain current is reached in the flow of electrons between the groups of compartments, etc.

In one set of embodiments, the fluids are controlled using a flow-switching element. The flow-switching element may be constructed and arranged to, at a first time, direct a first fluid from a first fluid source to a first exit and a second fluid from a second fluid source to a second exit, and at a second time, direct the first fluid from the first fluid to the second exit and the second fluid from the second fluid source to the first exit. In some cases, the flow-switching element may, at a first point in time, direct a first fluid from a first fluid source to an inlet of a first compartment (or a first common inlet of a first group of compartments) and a second fluid from a second fluid source to an inlet of a second compartment (or a second common inlet of a second group of compartments), and at a second point in time, direct the first fluid from the first fluid source to the inlet of the second compartment (or second common inlet of the second group of compartments) and the second fluid from the second fluid source to an inlet of the first compartment (or first common inlet of the first group of compartments). In addition, in some cases, the flow-switching element may, at a first point in time, direct a first fluid from a first fluid source to an inlet of a first compartment (or a first common inlet of a first group of compartments) and an inlet of a second compartment (or a second common inlet of a second group of compartments), and at a second point in time, direct a second fluid from a second fluid source to the inlet of the first compartment (or first common inlet of the first group of compartments) and the inlet of the second compartment (or second common inlet of the second group of compartments). The flow-switching element may be a single component, or comprise a plurality of components that together form the flow-switching element.

As a non-limiting example, as is shown in FIG. 6, flow-switching element 100 include first fluid inlet 101, second fluid inlet 102, first fluid outlet 111, and second fluid outlet 112. A variety of valves 121, 122, 123, and 124 can be opened or closed to route the fluids. When valves 121 and 124 are opened and valves 122 and 123 are closed, fluid from inlet 101 flows to outlet 111 and fluid from inlet 102 flows to outlet 112. However, when valves 121 and 124 are closed and valves 122 and 123 are opened, fluid from inlet 101 flows to outlet 112 and fluid from inlet 102 flows to outlet 111.

In some cases, the flow-switching element may allow other fluids to be introduced as well, e.g., into one or both exits. For example, between switches, there may be a period of time where a buffer or rinse fluid can be added, for instance, to separate the first fluid from the second fluid (or vice versa), to permit cleaning of the compartments, or the like.

As another non-limiting example, a flow-switching element may be constructed and arranged to, at a first time, flow a first fluid into some or all compartments of a device, and at a second time, flow a second fluid into some or all compartments of a device. For example, in one set of embodiments, a flow-switching element may be constructed and arranged to, at a first time, flow a lithium-rich (or other target ion-rich) fluid into a compartment, and at a second time, flow a rinse fluid into the compartment. At a third time, the flow-switching element may be constructed and arranged to flow a third fluid into the compartment, e.g., a lithium-poor (or other target ion-poor) fluid into the compartment. In some cases, some or all of the compartments of the device may have the same fluids therein, e.g., as controlled by the flow-switching element.

As discussed, some or all of the electrodes within the first group of compartments may be connected to each other, e.g., electrically, and some or all of the electrodes within the second group of compartments may be connected to each other, in accordance with one set of embodiments. The electrodes of the first group may be connected to the electrodes of the second group via one or more electrical pathways. In addition, the electrodes within a group may be connected to each other in certain embodiments, e.g., in any suitable configuration, e.g., in series, in parallel, or in other arrangements. Different groups of electrodes may also independently be connected to each other in the same or different configurations, e.g., in series, in parallel, or in other configurations.

In some embodiments, the pathway connecting the groups of electrodes may be substantially free of any voltage sources, e.g., a battery or an external voltage source. Accordingly, electrons and current may flow from the first group of electrodes to the second group of electrodes, or vice versa, without the imposition of an external potential, e.g., using a voltage source. This mode of operation may be considered to be galvanic, where the process proceeds based on the potential differences that may be created between the two groups of compartments due to the differences in concentration of lithium or other target ions. In addition, in some cases, the flow of current can be harnessed to generate electricity. The electricity may be used to facilitate the process described herein (for example, by powering fluid flows within the device), and/or harnessed and used externally. Accordingly, in some embodiments, power can be generated from the apparatus, e.g., as current flows from one set of electrodes to the other.

However, in certain cases, a voltage may be applied to the apparatus, e.g., creating a potential on the pathway connecting the groups of electrodes. In some cases, this potential may be used to drive the process, for example, to cause faster or better extraction of the target ion. The potential may be applied from an external voltage source, such as a battery, municipal power, or other power source (for example, fossil fuel or renewable power sources). This process may require additional electricity, but may be able to separate ions more rapidly than a galvanic process, and thus may be considered to be a supergalvanic process.

In addition, it should be understood, however, that in some cases, the potential may be applied to retard the process, which may cause slower or less efficient extraction of lithium or other target ions. This may be useful in some cases, for example, to control the rate at which the target ions are incorporated into or removed from the electrodes.

In one set of embodiments, the second fluid may contain one or more reagents that can be used to precipitate salts of the target ion. For example, if the target ion is lithium, the second fluid (e.g., the lithium-poor fluid) may contain a hydroxide, such as sodium hydroxide (NaOH) or potassium hydroxide (KOH), which may cause the lithium to precipitate as lithium hydroxide (LiOH). The second fluid may have a relatively higher pH, e.g., a pH of at least 5, at least 6, at least 7, at least 8, at least 9, at least 10, etc. In some cases, the LiOH may precipitate in an outlet or exit channel of the compartment.

For example, in one embodiment, lithium may be precipitated using sodium carbonate (soda ash) to make Li₂CO₃). In another embodiment, lithium may be precipitated using sodium hydroxide to make LiOH. As other examples, sodium carbonate can be used to precipitate certain divalents such as Mg or Ca to form MgCO₃ or CaCO₃, respectively; magnesium may be precipitated using CaCO₃ (lime) to make MgCO₃; and calcium may be precipitated using sodium oxalate to make calcium oxalate.

As another non-limiting example, the second fluid (e.g., the lithium-poor fluid) may contain carbon dioxide (CO₂) and/or carbonic acid (H₂CO₃, e.g., by sparging with CO₂ gas), which may cause the lithium to precipitate as lithium carbonate (Li₂CO₃). The CO₂ and/or H₂CO₃ may be present at any suitable concentration, e.g., a concentration of at least 1 mmol, at least 3 mmol, at least 5 mmol, at least 10 mmol, at least 20 mmol, at least 30 mmol, etc. In some cases, the Li2CO₃ may precipitate in an outlet or exit channel of the compartment.

An apparatus such as described herein can be used, in some aspects, to extract lithium from seawater, naturally occurring brines, or artificial brines from hydraulic fracturing, nuclear plant wastewater, reverse-osmosis or other water treatment processes, using local fresh water or desalinated water as the recovery solution. In one embodiment, the apparatus can be co-located with a geothermal power plant that produces additional electricity. In another embodiment, the apparatus can be co-located with a blue energy plant at a river estuary, where the system can use some electricity for galvanic discharge, and some for power generation. In yet other embodiments, the apparatus can be used to extract lithium from acidic leach liquors from hard-rock mining of spodumene or other lithium containing minerals, or from acidic leachates that arise in Li-ion battery recycling, as a compliment to hydrometallurgical processes. Other applications are also possible in other embodiments.

The following are each incorporated herein by reference in their entireties: U.S. Pat. Apl. Ser. No. 63/440,889, filed Jan. 24, 2023, entitled “Methods and Apparatuses for Galvanic Ion Extraction”; U.S. Pat. Apl. Ser. No. 63/444,484, filed Feb. 9, 2023, entitled “Flow Field Configurations and Methods for Separation Processes”; U.S. Pat. Apl. Ser. No. 63/513,519, filed Jul. 13, 2023, entitled “Methods and Apparatuses for Electrochemical Ion Exchange”; U.S. Pat. Apl. Ser. No. 63/513,532, filed Jul. 13, 2023, entitled “Processes and Apparatuses for Enriching Solutions”; and U.S. Pat. Apl. Ser. No. 63/513,538, filed Jul. 13, 2023, entitled “Flow Systems and Methods for Membraneless Separation.” In addition, the following, each filed on even date herewith, are each incorporated herein by reference in their entireties: a PCT patent application entitled “Flow Field Configurations and Methods for Separation Processes”; a PCT patent application entitled “Methods and Apparatuses for Electrochemical Ion Exchange”; a PCT patent application entitled “Processes and Apparatuses for Enriching Solutions”; a PCT patent application entitled “Flow Systems and Methods for Membraneless Separation”; a PCT patent application entitled “Electrode Composites for Electrochemical Ion Separation from Aqueous Solutions, and Methods Thereof”; and a PCT patent application entitled “Apparatuses, Manufacturing, and Operation of Electrochemical Stacks for Metals Extraction, and Methods Thereof.”

The following examples are intended to illustrate certain embodiments of the present disclosure, but do not exemplify the full scope of the disclosure.

### Example 1

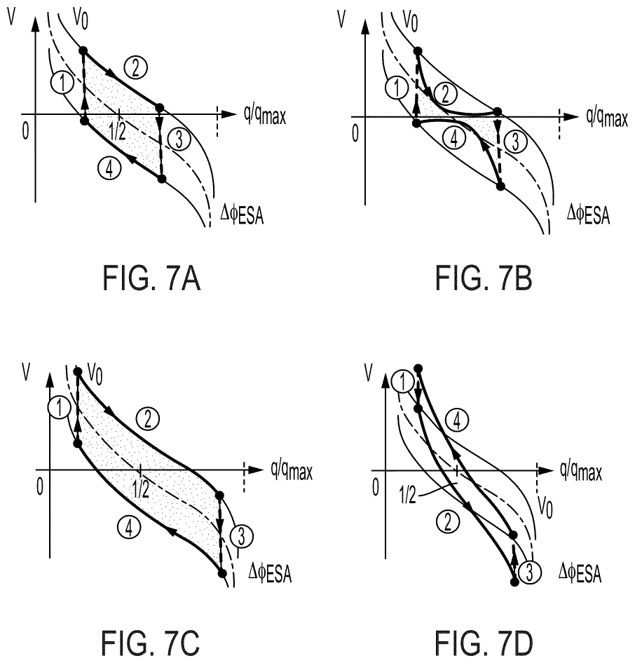

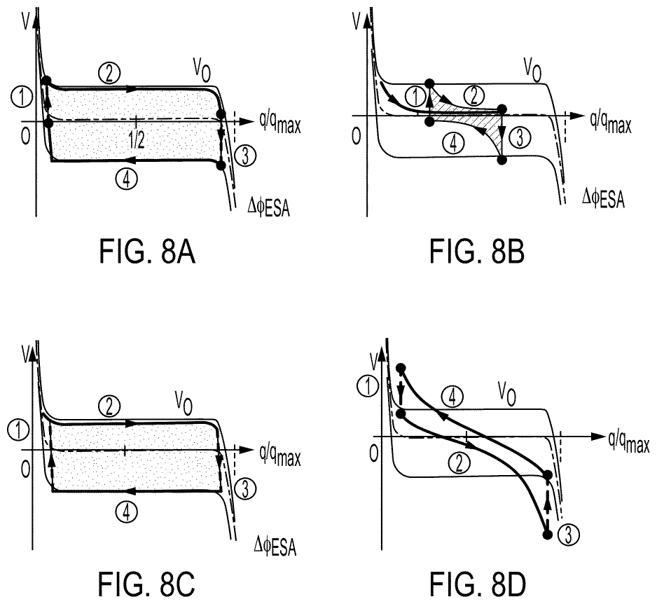

Without wishing to be bound by any theory, a variety of operating models that are available in some embodiments are described in this example, with reference to FIGS. 7 and 8. Two types of target-ion selective electrodes are discussed: (1) solid-solution electrodes (e.g., LMO), whose standard cell potential Δφ ESA(q) varies with state of charge (FIG. 7), and (2) phase-separating electrodes (e.g., LFP) or electrodeposition electrodes (e.g., Li metal), whose standard cell potential Δφ ESA remains approximately constant during capture and release of target ions (FIG. 8).

For solid solution electrodes, the open circuit potential is larger at first (e.g., around 1 V), which leads to faster extraction, but the voltage may decay with increasing state of discharge q, as the standard cell voltage decays and changes sign at q=0.5qₘₐₓ, which may make it more difficult to reach the full extraction capacity. For phase-separating or metal electrodes, the open circuit voltage is smaller (e.g., around 0.5 V) since it uses the electrolyte contributions from RED and CP, which may lead to slower extraction, but since it remains nearly constant, the full extraction capacity may more easily be reached at low rates.

In one embodiment, a system may be run using a fixed external resistance without imposing a voltage, e.g., using an external power supply. For low extraction rates with a large external resistance, the cell voltage may remain close to the open circuit voltage during discharge (step 1) and charge (step 3) until the voltage approaches zero, prior to attaining the full capacity, at which time sudden voltage jumps correspond to solution exchanges (steps 2 and 4), as shown in FIGS. 7A and 8A. The net electrical energy produced in one cycle may be determined using the enclosed area in the V-q plane. At high rates of extraction with a small external load, significant overpotentials may develop in some instances during both the charging and discharging steps, which may cause the voltage to decay to zero during the charge and discharge steps, which may make it difficult to reach the full capacity for extraction before solution exchanges are done, as shown in FIGS. 7B and 8B.

The system can also be run with voltage control to maintain a constant current in some embodiments. The discharge and charge steps can now begin as a galvanic process, which switches to a supergalvanic process when the voltage switches sign. At low currents, the cell voltage may stay close to the open circuit voltage until full extraction capacity is reached, and the solutions are exchanged, as shown in FIGS. 7C and 8C. In this case, the cell generates the maximum energy during each cycle, as indicated by the large shaded area. At high currents, large overpotentials may develop, which can become so large in some cases that the charge and discharge curves cross in the V-q plane, as shown in FIGS. 7D and 8D. At very high currents, the shaded area is traversed in the opposite sense, and the cell is consumes net electrical energy, and spends more time as supergalvanic cell than as galvanic cell during each cycle.

### Example 2

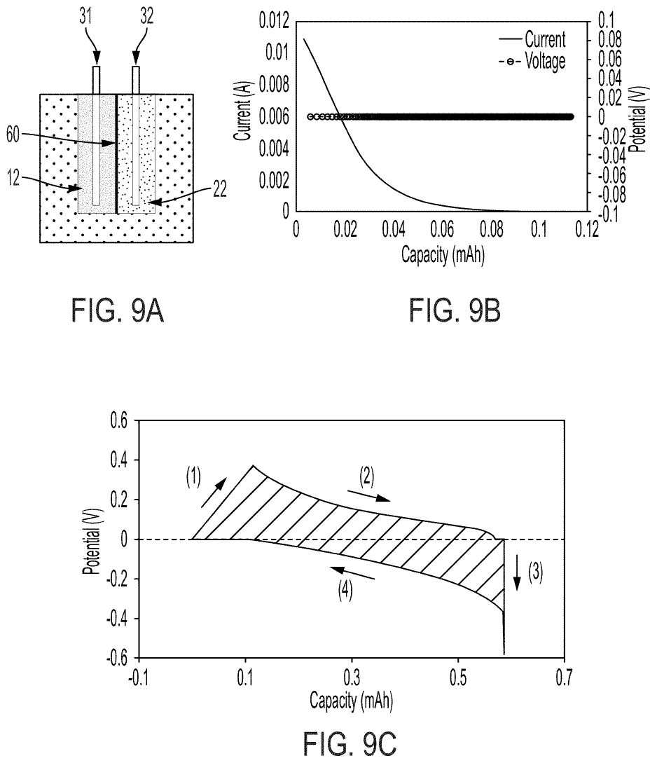

This example illustrates a galvanic ion extraction system in accordance with one embodiment. In this example, a system for extraction was conducted as shown in FIG. 9A, using delithiated LFP (lithium iron phosphate) as a counter electrode 31 in a first compartment 12 and lithiated LFP as a working electrode 32 in a second compartment 22. The separator between the compartments was Neosepta® AEM. The catholyte in the first compartment was 14 M LiCl (near the saturation limit), while the anolyte in the second compartment was deionized (DI) water.

The electrodes were connected to each other, with no applied potential or voltage source between the electrodes, i.e., the electrodes were shorted at 0 V. End of cycle was determined by a current cut-off of C/100 (22 microamperes). The limiting capacity of the system was 2.2mAh/cm².

The behavior of the first cycle during the 0 V short is shown in FIG. 9B, illustrating galvanic ion extraction. In this figure, positive current indicates ionic flow from the working electrode to the counter electrode which represents delithiation of the LFP into DI water and lithiation of the iron phosphate from the 14 M LiCl solution. In this example, it was found that about 5% of the total electrode capacity (~0.11 mAh) accessible through galvanic ion extraction.

This thus is an experimental demonstration of fast galvanic extraction with small External resistance and no voltage control. The following cycle was demonstrated using this system, with reference to FIG. 9C:
1. LFP (lithium iron phosphate) was placed in 14 M LiCl on one side of the system. FP (iron phosphate) was placed in deionized (DI) water on the other side. The two sides were separated by a Neosepta® AEM membrane.
2. The system was discharged at a low constant current (C/20) until 0 V (and cyclic voltammetry was used at 0 V until a current decay to C/50).
3. The fluids were swapped.
4. The system was charged at a low constant current (C/20) until 0 V (and cyclic voltammetry was used at OV until a current decay to C/50).

It should be noted that this cycle could be repeated multiple times, for example to continue to move lithium from the LiCl solution to the deionized water (i.e., recovery) solution. In some cases, the deionized water could be replaced with fresh deionized water, while the deionized water now containing lithium could be processed, for example to recover or use the lithium contained within it. For example, FIG. 9C shows the potential response to constant current extraction and release of Li into and out of the LFP electrodes. The electrodes were contained within a single compartment consisting of a Li-rich solution. FIGS. 11A and 11B illustrate the extraction and release capacities as a function of cycle number.

### Example 3

The following examples experimentally demonstrate several methods of Li extraction and release into solution using lithium iron phosphate (LFP) as a Li-selective electrode material, in accordance with certain embodiments as described herein. Lithium iron phosphate electrodes were fabricated by mixing LFP powder, conductive carbon powder, and a polyvinylidene fluoride (PVDF) binder in a solvent of n-methyl-2-pyrrolodone. After mixing, the resulting slurry was coated onto a carbon cloth substrate, by either dip-coating or blade casting, and then dried. To produce a Li-poor electrode, the electrodes were chemically oxidized in a 0.1 M Na₂S₂O₈ solution for 1.5 hours at 50° C., which resulted in an active material with a composition of Li₁₋ₓFePO₄ (FP), where x>0.

FIGS. 11A and 11B demonstrates multiple cycles of Li extraction and release from the electrodes. The two electrodes were suspended in a solution of 1 M LiCl and separated by a porous separator. On the first half-cycle, a positive constant current (C/10) was applied, simultaneously releasing Li from the LFP working electrode and inserting Li into the FP counter electrode. This half-cycle is referred to as the “Charge” cycle. On the next half-cycle, a negative constant current (C/10) was applied, which resulted in the simultaneous incorporation of Li into the working electrode and release of Li out of the counter electrode. Each complete cycle was repeated under the same conditions over 21 cycles.

This example demonstrates Li release and extraction from a cell using two solutions: 1) a Li-rich solution and 2) a Li-poor solution. In this cell, the LFP working electrode was suspended in a solution of deionized water (Li-poor), while the FP counter electrode was suspended in a solution of either 1 M LiCl (see FIGS. 8B, 9B, and 9C) or 14 M LiCl (see FIGS. 8D, 10, and 12). The two solutions were separated by an anion exchange membrane.

In FIG. 9B, the two electrodes were connected by a negligibly small external resistance, effectively setting the potential difference between the two electrodes to zero. Once connected, a positive current was observed, indicating spontaneous release of Li from the LFP and insertion of Li into the FP under no externally applied voltage. This result demonstrated that Li can be extracted and released purely based on differences in Li concentration, resulting in useful chemical work and a release of usable energy.

Two examples of an operating system are now described. In the first example, the cell was operated by applying a low constant current (C/20) until the cell reached a potential of 0 V. In the first half-cycle, Li was simultaneously released from the LFP into the Li-poor solution and extracted into the FP from the Li-rich solution. Although the applied current was positive, the cell potential remains negative, indicating the galvanic nature of the reaction. After switching the fluids such that the working electrode was in the Li-rich solution and the counter electrode was in the Li-poor solution, the cell potential became positive. Upon applying a negative current, the Li is released from the counter electrode and extracted into the working electrode. However, the positive cell potential similarly indicated the galvanic nature of the reverse reaction. Thus, both half cycles were galvanic in nature and required no energy input to facilitate the Li release/extraction.

This is shown in FIGS. 8B and 9C, demonstrating galvanic electroswing adsorption under no applied voltage. FIG. 8B shows the predicted behavior for fast galvanic electroswing adsorption (ESA) with small external resistance and no voltage control. FIG. 9C shows the experimental behavior of galvanic electroswing adsorption requiring no externally applied voltage. In Step 1, a Li-rich electrode (LFP) was placed in a Li-poor solution (deionized water) and a Li-poor electrode (FP) is placed in a Li-rich solution (14 M LiCl). In Step 2, the electrodes were connected via a small external resistance to facilitate galvanic ion extraction/release. In Step 3, the Li-rich and Li-poor solutions were switched. In Step 4, the electrodes were again connected via a small external resistance to facilitate galvanic ion release/extraction.

In the next example, a higher constant current was applied to the cell (C/10) until a non-zero potential is reached (0.6 and −0.6 V). In this example, the same reactions were occurring, however there was a change in sign of the potential during each half-cycle. This is indicative of additional energy required to facilitate the reaction at this higher rate, representing a supergalvanic mode of operation.

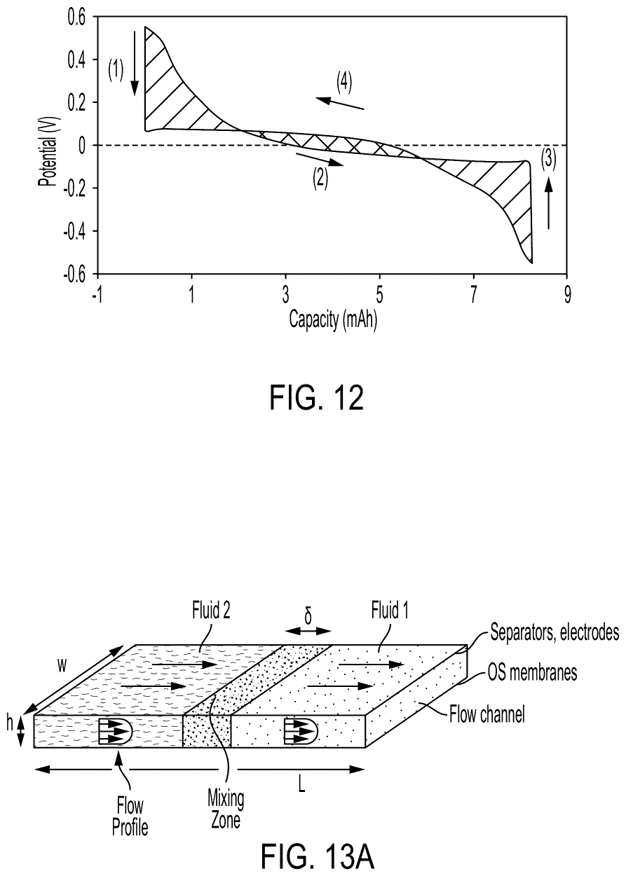

This is shown in FIGS. 8D and 12, demonstrating supergalvanic electroswing adsorption under large applied currents. FIG. 8D shows the predicted behavior for fast super-galvanic electroswing adsorption (ESA) under large currents. FIG. 12 shows experimental behavior of super-galvanic electroswing adsorption. In Step 1, a Li-rich electrode (LFP) was placed in a Li-poor solution (deionized water) and a Li-poor electrode is placed in a Li-rich solution (1 M LiCl). In Step 2, the electrodes were connected via a small external resistance to facilitate super-galvanic ion extraction/release. In Step 3, the Li-rich and Li-poor solutions were switched. In Step 4, the electrodes were again connected via a small external resistance to facilitate super-galvanic ion release/extraction.

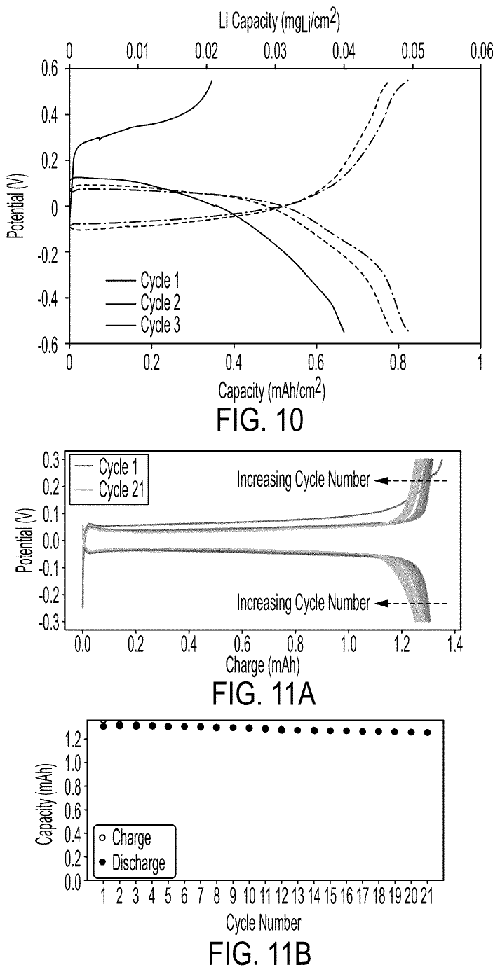

Supergalvanic operation over multiple cycles is also demonstrated in FIG. 10, which shows supergalvanic lithium extraction at constant current over multiple cycles. In the first half-cycle, the cell potential increased as Li is released from the working electrode (LFP) into the Lipoor solution (deionized water) and simultaneously Li was extracted from the Li-rich solution (1M LiCl) into the counter electrode (FP). After the half-cycle, the two solutions were swapped, such that the working electrode was in contact with the Li-rich solution and the counter electrode was in contact with the Li-poor solution. On the next half-cycle, an opposite current was applied to insert Li from the Li-rich solution into the working electrode and release Li into the Li-poor solution from the counter electrode, causing a decrease in cell potential.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus for galvanic lithium extraction, comprising:
a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack;
a source of a lithium-rich fluid;
a source of a lithium-poor fluid;
a flow-switching element able to switch between a first state and a second state, wherein: (i) in the first state, fluid from the source of the lithium-rich fluid is in fluid communication with the first group of compartments and fluid from the source of the lithium-poor fluid is in fluid communication with the second group of compartments, and (ii) in the second state, fluid from the source of the lithium-rich fluid is in fluid communication with the second group of compartments and fluid from the source of the lithium-poor fluid is in fluid communication with the first group of compartments; and
an electrical pathway connecting the electrodes of the first group of compartments and the electrodes of the second group of compartments, the electrical pathway being free of a voltage source.

2. The apparatus of claim 1, wherein the lithium-selective electrode comprises an active material.

3. The apparatus of claim 2, wherein the active material comprises a solid metal.

4. The apparatus of claim 3, wherein the solid metal comprises lithium metal.

5. The apparatus of any one of claims 2-4, wherein the active material comprises a lithium-ion intercalation material.

6. The apparatus of claim 5, wherein the lithium-ion intercalation material comprises LiMePO₄, wherein Me comprises one or more transition metals.

7. The apparatus of any one of claims 5-6, wherein the lithium-ion intercalation material comprises LiMeO₂, wherein Me comprises one or more transition metals.

8. The apparatus of any one of claims 5-7, wherein the lithium-ion intercalation material comprises lithium iron phosphate (LFP).

9. The apparatus of any one of claims 5-8, wherein the lithium-ion intercalation material comprises lithium titanium phosphate (LTP).

10. The apparatus of any one of claims 5-9, wherein the lithium-ion intercalation material comprises lithium manganese oxide (LMO).

11. The apparatus of any one of claims 5-10, wherein the lithium-ion intercalation material comprises lithium titanium oxide (LTO).

12. The apparatus of any one of claims 5-11, wherein the lithium-ion intercalation material comprises nickel manganese cobalt oxide (NMC).

13. The apparatus of any one of claims 5-12, wherein the lithium-ion intercalation material comprises nickel cobalt aluminum oxide (NCA).

14. The apparatus of any one of claims 5-13, wherein the lithium-ion intercalation material comprises lithium cobalt oxide (LCO).

15. The apparatus of any one of claims 5-14, wherein the lithium-ion intercalation material comprises manganese.

16. The apparatus of any one of claims 5-15, wherein the lithium-ion intercalation material comprises nickel.

17. The apparatus of any one of claims 1-16, wherein the lithium-selective electrode further comprises a coating.

18. The apparatus of claim 17, wherein the coating surrounds at least a portion of the active material.

19. The apparatus of any one of claims 17 or 18, wherein the coating comprises the active material.

20. The apparatus of any one of claims 17-19, wherein the coating comprises a lithium-selective material.

21. The apparatus of claim 20, wherein the lithium-selective material comprises lithium titanium oxide.

22. The apparatus of any one of claims 20 or 21, wherein the lithium-selective material comprises polydopamine carbon.

23. The apparatus of any one of claims 20-22, wherein the lithium-selective material comprises carbon nanotubes.

24. The apparatus of any one of claims 1-23, wherein the lithium-selective electrode comprises a ceramic.

25. The apparatus of claim 24, wherein the ceramic comprises alumina.

26. The apparatus of any one of claims 24 or 25, wherein the ceramic comprises titania.

27. The apparatus of any one of claims 24-26, wherein the ceramic comprises zirconia.

28. The apparatus of any one of claims 24-27, wherein the ceramic comprises phosphate glass.

29. The apparatus of any one of claims 1-28, wherein the lithium-selective electrode comprises a conducting additive.

30. The apparatus of claim 29, wherein the additive comprises carbon.

31. The apparatus of any one of claims 29 or 30, wherein the additive comprises graphitic carbon.

32. The apparatus of any one of claims 29-31, wherein the additive comprises carbon black.

33. The apparatus of any one of claims 29-32, wherein the additive comprises graphene oxide.

34. The apparatus of any one of claims 1-33, wherein the lithium-selective electrode comprises a binder.

35. The apparatus of claim 34, wherein the binder comprises polyvinylidene fluoride (PVDF).

36. The apparatus of any one of claims 34 or 35, wherein the binder comprises polypyrrole (PPy).

37. The apparatus of any one of claims 34-36, wherein the binder comprises polyethylene oxide (PEO).

38. The apparatus of any one of claims 1-37, wherein the lithium-selective electrode is porous.

39. The apparatus of claim 38, wherein the lithium-selective electrode has a porosity of at least 25%.

40. The apparatus of any one of claims 38 or 39, wherein the lithium-selective electrode has a porosity of at least 30%.

41. The apparatus of any one of claims 38-40, wherein the lithium-selective electrode has a porosity of between 25% and 70%.

42. The apparatus of any one of claims 38-41, wherein the lithium-selective electrode comprises particles.

43. The apparatus of claim 42, wherein the particles form a packed bed within the lithium-selective electrode.

44. The apparatus of any one of claims 42 or 43, wherein the particles comprise carbon particles.

45. The apparatus of any one of claims 42-44, wherein the particles comprise Vulcan carbon.

46. The apparatus of any one of claims 42-45, wherein the particles comprise petroleum coke.

47. The apparatus of any one of claims 1-46, wherein the lithium-selective electrode comprises fibers.

48. The apparatus of any one of claims 1-47, wherein the lithium-selective electrode comprises woven fibers.

49. The apparatus of any one of claims 1-48, wherein the lithium-selective electrode comprises nonwoven fibers.

50. The apparatus of any one of claims 1-49, wherein the porous electrode is formed using a porogen.

51. The apparatus of any one of claims 1-50, wherein the lithium-selective electrode is a flow-through electrode.

52. The apparatus of any one of claims 1-51, wherein the lithium-selective electrode comprises a current collector.

53. The apparatus of claim 52, wherein the current collector comprises graphite.

54. The apparatus of any one of claims 52 or 53, wherein the current collector comprises titanium.

55. The apparatus of any one of claims 52-54, wherein the current collector comprises aluminum.

56. The apparatus of any one of claims 52-55, wherein the current collector comprises a metal mesh.

57. The apparatus of any one of claims 52-56, wherein the current collector comprises a porous conducting material.

58. The apparatus of claim 57, wherein the porous conducting material has a porosity of less than 75%.

59. The apparatus of any one of claims 1-58, wherein the anion is chloride.

60. The apparatus of any one of claims 1-58, wherein the anion is sulfate.

61. The apparatus of any one of claims 1-60, wherein the anion-selective membrane comprises an ionomer.

62. The apparatus of any one of claims 1-61, wherein the anion-selective membrane comprises Neosepta®.

63. The apparatus of any one of claims 1-62, wherein the anion-selective membrane comprises a block copolymer.

64. The apparatus of claim 63, wherein the block copolymer has at least one positively charged block.

65. The apparatus of any one of claims 1-64, wherein the anion-selective membrane comprises a ceramic substrate.

66. The apparatus of claim 65, wherein the ceramic substrate comprises a positively charged surface.

67. The apparatus of any one of claims 65 or 66, wherein the ceramic comprises alumina.

68. The apparatus of any one of claims 65-67, wherein the ceramic comprises silica.

69. The apparatus of any one of claims 1-68, wherein the anion-selective membrane comprises a polymeric substrate.

70. The apparatus of claim 69, wherein the polymeric substrate comprises a positively charged surface.

71. The apparatus of any one of claims 1-70, wherein the anion-selective membrane comprises ion-exchange resin.

72. The apparatus of claim 71, wherein at least some of the resin is present within the anion-selective membrane as beads.

73. The apparatus of any one of claims 71 or 72, wherein at least some of the resin is present within the anion-selective membrane as wafers.

74. The apparatus of any one of claims 1-73, wherein the stack comprises at least 10 repeat units.

75. The apparatus of any one of claims 1-74, wherein the stack comprises at least 50 repeat units.

76. The apparatus of any one of claims 1-75, wherein at least 50% of the lithium-selective electrodes in the stack have substantially the same non-lithium composition.

77. The apparatus of any one of claims 1-76, wherein at least 90% of the lithium-selective electrodes in the stack have substantially the same non-lithium composition.

78. The apparatus of any one of claims 1-77, wherein the lithium-rich fluid comprises salt-lake brine.

79. The apparatus of any one of claims 1-78, wherein the lithium-rich fluid comprises geothermal brine.

80. The apparatus of any one of claims 1-79, wherein the lithium-rich fluid comprises artificial desalination brine.

81. The apparatus of any one of claims 1-80, wherein the lithium-rich fluid comprises hard-rock leachate.

82. The apparatus of any one of claims 1-81, wherein the lithium-rich fluid comprises battery leachate.

83. The apparatus of any one of claims 1-82, wherein the lithium-rich fluid comprises seawater.

84. The apparatus of any one of claims 1-83, wherein the lithium-rich fluid comprises a lithium ion concentration of at least 0.2 mol %.

85. The apparatus of any one of claims 1-84, wherein the lithium-rich fluid comprises a lithium ion concentration of at least 0.5 mol %.

86. The apparatus of any one of claims 1-85, wherein the lithium-rich fluid comprises a lithium ion concentration of at least 1 mol %.

87. The apparatus of any one of claims 1-86, wherein the lithium-rich fluid comprises a lithium ion concentration of at least 3 mol %.

88. The apparatus of any one of claims 1-87, wherein the lithium-poor fluid comprises a lithium ion concentration of no more than 0.01 mol %.

89. The apparatus of any one of claims 1-88, wherein the lithium-poor fluid comprises fresh water.

90. The apparatus of any one of claims 1-89, wherein the lithium-poor fluid comprises naturally-occurring fresh water.

91. The apparatus of any one of claims 1-90, wherein the lithium-poor fluid comprises purified water.

92. The apparatus of any one of claims 1-91, wherein the lithium-poor fluid comprises desalinated water.

93. The apparatus of any one of claims 1-92, wherein the lithium-poor fluid has a pH of at least 5.

94. The apparatus of any one of claims 1-93, wherein the lithium-poor fluid has a pH of at least 6.

95. The apparatus of any one of claims 1-94, wherein the lithium-poor fluid comprises CO₂ at a concentration of at least 1 mmol.

96. The apparatus of any one of claims 1-95, wherein the lithium-poor fluid comprises CO₂ at a concentration of at least 5 mmol.

97. The apparatus of any one of claims 1-96, wherein the lithium-poor fluid comprises CO₂ at a concentration of at least 10 mmol.

98. The apparatus of any one of claims 1-97, wherein the lithium-poor fluid comprises CO₂ at a concentration of at least 30 mmol.

99. The apparatus of any one of claims 1-98, wherein fluid in adjacent compartments within the stack flows in parallel.

100. The apparatus of any one of claims 1-99, wherein fluid in adjacent compartments within the stack flows antiparallel.

101. The apparatus of any one of claims 1-100, wherein fluid in adjacent compartments within the stack flows orthogonally.

102. The apparatus of any one of claims 1-101, wherein the stack has a rectangular configuration of compartments.

103. The apparatus of any one of claims 1-102, wherein the stack has a cylindrical configuration of compartments.

104. A method for galvanic extraction of lithium, comprising:
providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack;
at a first time, flowing a lithium-rich fluid through the first group of compartments and a lithium-poor fluid through the second group of compartments such that anions pass across the anion-selective membrane from the first group of compartments to the second group of compartments, and current flows from the electrodes of the first group of compartments to the electrodes of the second group of compartments; and
at a second time, flowing the lithium-rich fluid through the second group of compartments and the lithium-poor fluid through the first group of compartments such that anions pass across the anion-selective membrane from the second group of compartments to the first group of compartments, and current flows from the electrodes of the second group of compartments to the electrodes of the first group of compartments.

105. The method of claim 104, wherein at the first time, current flows from the electrodes of the first group of compartments to the electrodes of the second group of compartments without imposing of an external potential therebetween, and at the second time, current flows from the electrodes of the second group of compartments to the electrodes of the first group of compartments without imposing an external potential therebetween.

106. The method of any one of claims 104 or 105, wherein at the first time, a potential is created between the electrodes of the first group of compartments and the electrodes of the second group of compartments that causes the current to from the electrodes of the first group of compartments to the electrodes of the second group of compartments, and at the second time, a potential is created between the electrodes of the second group of compartments and the electrodes of the first group of compartments that causes the current to from the electrodes of the second group of compartments to the electrodes of the first group of compartments.

107. The method of any one of claims 104-106, wherein at the first time, lithium ions are incorporated from the lithium-rich fluid into the lithium-selective electrodes contained within the first group of compartments and lithium ions are removed from the lithium-selective electrodes contained within the second group of compartments into the lithium-poor fluid, and at the second time, lithium ions are incorporated from the lithium-rich fluid into the lithium-selective electrodes contained within the second group of compartments and lithium ions are removed from the lithium-selective electrodes contained within the first group of compartments into the lithium-poor fluid.

108. The method of any one of claims 104-107, further comprising using at least some of the current from the stack to produce power.

109. The method of any one of claims 104-108, further comprising, at the first time, applying an external potential to cause the current to flow from the electrodes of the first group of compartments to the electrodes of the second group of compartments, and at the second time, applying an external potential to cause the current to flow from the electrodes of the first group of compartments to the electrodes of the second group of compartments.

110. A method for galvanic extraction of lithium, comprising:
providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, the compartments of the first group of compartments and the compartments of the second group of compartments alternating within the stack;
at a first time, flowing a lithium-rich fluid through the first group of compartments and a lithium-poor fluid through the second group of compartments such that anions pass across the anion-selective membrane from the first group of compartments to the second group of compartments, without imposing an external potential therebetween; and
at a second time, flowing the lithium-rich fluid through the second group of compartments and the lithium-poor fluid through the first group of compartments such that anions pass across the anion-selective membrane from the second group of compartments to the first group of compartments, without imposing an external potential therebetween.

111. The method of claim 110, wherein at the first time, current flows from the electrodes of the first group of compartments to the electrodes of the second group of compartments, and at the second time, current flows from the electrodes of the second group of compartments to the electrodes of the first group of compartments.

112. The method of claim 111, further comprising using at least some of the current to produce power.

113. The method of any one of claims 110-112, wherein at the first time, a potential is created between the first group of compartments and the second group of compartments that causes current to flow from the electrodes of the first group of compartments to the electrodes of the second group of compartments, and at the second time, a potential is created between the second group of compartments and the first group of compartments that causes current to flow from the electrodes of the second group of compartments to the electrodes of the first group of compartments.

114. The method of any one of claims 110-113, wherein at the first time, lithium ions are incorporated from the lithium-rich fluid into the lithium-selective electrodes contained within the first group of compartments and lithium ions are removed from the lithium-selective electrodes contained within the second group of compartments into the lithium-poor fluid, and at the second time, lithium ions are incorporated from the lithium-rich fluid into the lithium-selective electrodes contained within the second group of compartments and lithium ions are removed from the lithium-selective electrodes contained within the first group of compartments into the lithium-poor fluid.

115. A method for galvanic extraction of lithium, comprising:
providing a stack comprising a plurality of repeat units, each repeat unit comprising a lithium-selective electrode and being separated from an adjacent repeat unit by an anion-selective membrane, wherein the lithium-selective electrodes comprise a first group of electrodes in electrical communication via a first electrical network and a second group of electrodes in electrical communication via a second electrical network, the electrodes of the first group of electrodes and the electrodes of the second group of electrodes alternating within the stack;
at a first time, incorporating lithium ions in the first group of electrodes, removing lithium ions from the second group of electrodes, passing anions across the anion-selective membrane in a first direction, and creating a potential between the first group of electrodes and the second group of electrodes, wherein the potential causes current to flow from the first group of electrodes to the second group of electrodes; and
at a second time, removing lithium ions from the first group of electrodes, incorporating lithium ions in the second group of electrodes, passing anions across the anion-selective membrane in a second direction opposite the first direction, and creating a potential between the second group of electrodes and the first group of electrodes, wherein the potential causes current to flow from the second group of electrodes to the first group of electrodes.

116. The method of claim 115, wherein incorporating lithium ions in the first group of electrodes comprises depositing the lithium ions on the first group of electrodes comprises, and incorporating lithium ions in the second group of electrodes comprises depositing the lithium ions on the second group of electrodes.

117. The method of any one of claims 115 or 116, wherein at the first time, the potential is created between the first group of electrodes and the second group of electrodes without imposing an external potential therebetween, and at the second time, the potential is created between the second group of electrodes and the first group of electrodes without imposing an external potential therebetween.

118. The method of any one of claims 115-117, wherein at the first time, the method comprises flowing a lithium-rich fluid over the first group of electrodes and flowing a lithium-poor fluid over the second group of electrodes, and at the second time, the method comprises flowing the lithium-poor fluid over the first group of electrodes and flowing the lithium-rich fluid over the second group of electrodes.

119. The method of any one of claims 115-118, further comprising using at least some of the current from the stack to produce power.

120. The method of any one of claims 115-119, further comprising, at the first time, applying an external potential to cause the current to flow from the first group of electrodes to the second group of electrodes, and at the second time, applying an external potential to cause the current to flow from the second group of electrodes to the first group of electrodes.

121. An apparatus for galvanic lithium extraction, comprising:
a stack comprising a plurality of repeat units, each repeat unit comprising a compartment containing a lithium-selective electrode and being separated from an adjacent repeat unit by an anion-selective membrane;
a first electrical network in electrical communication with a first group of the lithium-selective electrodes;
a second electrical network in electrical communication with a second group of the lithium-selective electrodes, wherein the electrodes of the first group of electrodes and the electrodes of the second group of electrodes alternate within the stack; and
an electrical pathway connecting the first group of electrodes and the second group of electrodes, the electrical pathway being free of a voltage source.

122. A method for galvanic extraction of lithium, comprising:
providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, wherein the compartments of the first group of compartments and the compartments of the second group of compartments alternate within the stack;
flowing a lithium-rich fluid through the first group of compartments;
flowing a lithium-poor fluid through the second group of compartments;
passing anions across the anion-selective membrane from the first group of compartments to the second group of compartments; and
passing current from the electrodes of the first group of compartments to the electrodes of the second group of compartments.

123. A method for galvanic extraction of lithium, comprising:
providing a stack comprising a plurality of repeat units, each repeat unit comprising a compartment containing a lithium-selective electrode and being separated from an adjacent repeat unit by an anion-selective membrane, wherein the compartments comprise a first group of compartments and a second group of compartments, wherein the compartments of the first group of compartments and the compartments of the second group of compartments alternate within the stack;
flowing a lithium-rich fluid through the first group of compartments;
flowing a lithium-poor fluid through the second group of compartments;
passing anions across the anion-selective membranes from the first group of compartments to the second group of compartments; and
causing current to flow from the electrodes of the first group of compartments to the electrodes of the second group of compartments without imposing an external potential therebetween.

124. A method for galvanic extraction of lithium, comprising:
providing a stack comprising a plurality of repeat units, each repeat unit comprising a lithium-selective electrode and being separated from an adjacent repeat unit by an anion-selective membrane, wherein the lithium-selective electrodes comprise a first group of electrodes in electrical communication via a first electrical network and a second group of electrodes in electrical communication via a second electrical network, wherein the electrodes of the first group of electrodes and the electrodes of the second group of electrodes alternate within the stack;
incorporating lithium ions in the first group of electrodes;
removing lithium ions from the second group of electrodes;
passing anions across the anion-selective membrane; and
causing current to flow from the first group of electrodes to the second group of electrodes.

125. An apparatus for galvanic lithium extraction, comprising:
a first compartment containing a first lithium-selective electrode;
a second compartment containing a second lithium-selective electrode;
an anion-selective membrane separating the first compartment and the second compartment;
a source of a lithium-rich fluid;
a source of a lithium-poor fluid;
a flow-switching element able to switch between a first state and a second state, wherein: (i) in the first state, fluid from the source of the lithium-rich fluid is in fluid communication with the first compartment and fluid from the source of the lithium-poor fluid is in fluid communication with the second compartment, and (ii) in the second state, fluid from the source of the lithium-rich fluid is in fluid communication with the second compartment and fluid from the source of the lithium-poor fluid is in fluid communication with the first compartment; and
an electrical pathway connecting the first lithium-selective electrode in the first compartment and the second lithium-selective electrode in the second compartment, the electrical pathway being free of a voltage source.

126. A method for galvanic extraction of lithium, comprising:
providing a first compartment containing a first lithium-selective electrode and a second compartment containing a second lithium-selective electrode, the first compartment and the second compartment being separated by an anion-selective membrane;
at a first time, flowing a lithium-rich fluid through the first compartment and a lithium-poor fluid through the second compartment such that anions pass across the anion-selective membrane from the first compartment to the second compartment, and current flows from the first lithium-selective electrode to the second lithium-selective electrode; and
at a second time, flowing the lithium-rich fluid through the second compartment and the lithium-poor fluid through the first compartment such that anions pass across the anion-selective membrane from the second compartment to the first compartment, and current flows from the second lithium-selective electrode to the first lithium-selective electrode.

127. A method for galvanic extraction of lithium, comprising:
providing a first compartment containing a first lithium-selective electrode and a second compartment containing a second lithium-selective electrode, the first compartment and the second compartment being separated by an anion-selective membrane;
at a first time, flowing a lithium-rich fluid through the first compartment and a lithium-poor fluid through the second compartment such that anions pass across the anion-selective membrane from the first compartment to the second compartment, without imposing an external potential between the first electrode and the second electrode; and
at a second time, flowing the lithium-rich fluid through the second compartment and the lithium-poor fluid through the first compartment such that anions pass across the anion-selective membrane from the second compartment to the first compartment, without imposing an external potential between the second electrode and the first electrode.

128. A method for galvanic extraction of lithium, comprising:
providing a first compartment containing a first lithium-selective electrode and a second compartment containing a second lithium-selective electrode, the first compartment and the second compartment being separated by an anion-selective membrane;
at a first time, incorporating lithium ions in the first lithium-selective electrode, removing lithium ions from the second lithium-selective electrode, passing anions across the anion-selective membrane in a first direction, and creating a potential between the first lithium-selective electrode and the second lithium-selective electrode, wherein the potential causes current to flow from the first lithium-selective electrode to the second lithium-selective electrode; and
at a second time, removing lithium ions from the first lithium-selective electrode, incorporating lithium ions in the second lithium-selective electrode, passing anions across the anion-selective membrane in a second direction opposite the first direction, and creating a potential between the second lithium-selective electrode and the first lithium-selective electrode, wherein the potential causes current to flow from the second lithium-selective electrode to the first lithium-selective electrode.

129. An apparatus for galvanic lithium extraction, comprising:
a first compartment containing a first lithium-selective electrode;
a second compartment containing a second lithium-selective electrode;
an anion-selective membrane separating the first compartment and the second compartment;
a source of a lithium-rich fluid in fluid communication with the first compartment;
a source of a lithium-poor fluid in fluid communication with the second compartment; and
an electrical pathway connecting the first lithium-selective electrode in the first compartment and the second lithium-selective electrode in the second compartment, the electrical pathway being free of a voltage source.

130. A method for galvanic extraction of lithium, comprising:
flowing a lithium-rich fluid through a first compartment containing a first lithium-selective electrode;
flowing a lithium-poor fluid through a second compartment containing a second lithium-selective electrode;
passing anions from the first compartment to the second compartment across an anion-selective membrane separating the first compartment and the second compartment; and
creating a potential between the first lithium-selective electrode and the second lithium-selective electrode, wherein the potential causes current to flow from the first lithium-selective electrode to the second lithium-selective electrode.

131. A method for galvanic extraction of lithium, comprising:
flowing a lithium-rich fluid through a first compartment containing a first lithium-selective electrode;
flowing a lithium-poor fluid through a second compartment containing a second lithium-selective electrode;
passing anions from the first compartment to the second compartment across an anion-selective membrane separating the first compartment and the second compartment; and
passing a current from the first lithium-selective electrode to the second lithium-selective electrode without imposing an external potential therebetween.

132. A method for galvanic extraction of lithium, comprising:
incorporating lithium ions in a first lithium-selective electrode in a first compartment;
removing lithium ions from a second lithium-selective electrode in a second compartment;
passing anions across an anion-selective membrane separating the first compartment and the second compartment; and
creating a potential between the first lithium-selective electrode and the second lithium-selective electrode, wherein the potential causes current to flow from the first lithium-selective electrode to the second lithium-selective electrode.

133. An apparatus for galvanic extraction of a target ion, comprising:
a stack comprising a plurality of repeat units, each repeat unit comprising a compartment containing an electrode selective to the target ion and being separated from an adjacent repeat unit by an counterion-selective membrane, wherein the compartments comprise a first group of compartments and a second group of compartments, the compartments of the first group of compartments and the compartments of the second group of compartments alternating within the stack;
a source of a first fluid rich in the target ion;
a source of a second fluid poor in the target ion;
a flow-switching element able to switch between a first state and a second state, wherein: (i) in the first state, fluid from the source of the first fluid is in fluid communication with the first group of compartments and fluid from the source of the second fluid is in fluid communication with the second group of compartments, and (ii) in the second state, fluid from the source of the first fluid is in fluid communication with the second group of compartments and fluid from the source of the second fluid is in fluid communication with the first group of compartments; and
an electrical pathway connecting the electrodes of the first group of compartments and the electrodes of the second group of compartments, the electrical pathway being free of a voltage source.

134. The apparatus of claim 133, wherein the target ion is lithium.

135. The apparatus of claim 133, wherein the target ion is silver.

136. The apparatus of claim 133, wherein the target ion is gold.

137. The apparatus of claim 133, wherein the target ion is copper.

138. The apparatus of claim 133, wherein the target ion is a lanthanide.

139. The apparatus of claim 133, wherein the target ion is an actinide

140. An apparatus for galvanic extraction of a target ion, comprising:
a first compartment containing a first electrode selective to the target ion;
a second compartment containing a second electrode selective to the target ion;
a counterion-selective membrane separating the first compartment and the second compartment;
a source of a first fluid rich in the target ion in fluid communication with the first compartment;
a source of a second fluid poor in the target ion in fluid communication with the second compartment; and
an electrical pathway connecting the first electrode in the first compartment and the second electrode in the second compartment, the electrical pathway being free of a voltage source.

141. An apparatus for galvanic extraction of a target ion, comprising:
a stack comprising a plurality of repeat units, each repeat unit comprising a compartment containing an electrode selective to the target ion and being separated from an adjacent repeat unit by a counterion-selective membrane;
a first electrical network in electrical communication with a first group of the electrodes selective to the target ion;
a second electrical network in electrical communication with a second group of the electrodes selective to the target ion, wherein the electrodes of the first group of electrodes and the electrodes of the second group of electrodes alternate within the stack; and
an electrical pathway connecting the first group of electrodes and the second group of electrodes, the electrical pathway being free of a voltage source.

142. An apparatus for galvanic extraction of a target ion, comprising:
a first compartment containing a first electrode selective to the target ion;
a second compartment containing a second electrode selective to the target ion;
a counterion-selective membrane separating the first compartment and the second compartment;
a source of a first fluid rich in the target ion;
a source of a second fluid poor in the target ion;
a flow-switching element able to switch between a first state and a second state, wherein: (i) in the first state, fluid from the source of the first fluid is in fluid communication with the first compartment and fluid from the source of the second fluid is in fluid communication with the second compartment, and (ii) in the second state, fluid from the source of the first fluid is in fluid communication with the second compartment and fluid from the source of the second fluid is in fluid communication with the first compartment; and
an electrical pathway connecting the first electrode in the first compartment and the second electrode in the second compartment, the electrical pathway being free of a voltage source.
